(19) United States
(12) Patent Application Publication
(10) Pub. No.: US 2023/0303091 A1
(43) Pub. Date: Sep. 28, 2023

(54) SIMULATION-BASED OPTIMIZATION FRAMEWORK FOR CONTROLLING ELECTRIC VEHICLES

(71) Applicant: Cornell University, Ithaca, NY (US)

(72) Inventor: Fengqi You, Ithaca, NY (US)

(21) Appl. No.: 18/019,657

(22) PCT Filed: Aug. 19, 2021
(86) PCT No.: PCT/US2021/046643

§ 371 Date: Feb. 3, 2023

Related U.S. Application Data
(60) Provisional application No. 63/067,468, filed on Aug. 19, 2020.

(51) Int. Cl. B60W 50/00; B60L 3/00; B60W 30/182

(52) U.S. Cl. CPC B60W 50/0098; B60L 3/00; B60W 30/182; B60L 2240/00; B60L 2240/545; B60L 2240/70

(57) ABSTRACT

An apparatus formulates a scheduling optimization problem for controlling the operation of an electric vehicle between multiple operating states based at least in part on battery status information of the electric vehicle, decomposes the scheduling optimization problem into a plurality of subproblems associated with respective sequences of time slots, implements an electric vehicle simulator to generate updated values of the battery status information, including one or more predicted values, for use in solving the subproblem for each of one or more of the sequences of time slots, based at least in part on a solution to the subproblem for a previous one of the sequences of time slots, and generates one or more control signals for the electric vehicle for each of one or more of the sequences of time slots based at least in part on the corresponding solution to the subproblem for that sequence of time slots.

### RELATED APPLICATION

The present application claims priority to U.S. Provisional Patent Application Ser. No. 63/067,468, filed Aug. 19, 2020, which is incorporated by reference herein in its entirety.

### FIELD

The field relates generally to electric vehicles, such as autonomous electric vehicles, and more particularly to techniques for controlling electric vehicles.

### BACKGROUND

The electric vehicle market is booming due to growing environmental concerns and tight regulations on conventional internal combustion engine (ICE) vehicles. To reduce greenhouse gas emissions, many regions have encouraged taxi companies to replace ICE vehicles with electric vehicles. Autonomous driving technologies can facilitate this transition process, by eliminating the labor cost of the driver and providing all-day services. However, unlike ICE vehicles, which do not have the battery degradation problem, electric vehicles generally require periodic replacement of their Lithium-ion (“Li-ion”) batteries. Such replacement accounts for a significant portion of the operating costs of an electric taxi, since the Li-ion battery is typically the most expensive component of an electric vehicle. Conventional techniques are deficient in that they fail to provide adequate control of electric vehicles in a manner that can optimize distinct performance goals such as battery life and productivity, particularly across a fleet of electric taxis or other types of electric vehicles.

### SUMMARY

Illustrative embodiments disclosed herein provide a simulation-based optimization framework for controlling electric vehicles, such as autonomous electric vehicles. Such embodiments can advantageously extend battery life while also maximizing productivity of a fleet of electric vehicles.

An apparatus in one illustrative embodiment comprises one or more processing devices, each comprising a processor coupled to a memory. The one or more processing devices are collectively configured to formulate a scheduling optimization problem for controlling the operation of an electric vehicle between a plurality of operating states based at least in part on battery status information of the electric vehicle, to decompose the scheduling optimization problem into a plurality of subproblems associated with respective sequences of time slots, to implement an electric vehicle simulator to generate updated values of the battery status information, including one or more predicted values, for use in solving the subproblem for each of one or more of the sequences of time slots, based at least in part on a solution to the subproblem for a previous one of the sequences of time slots, and to generate one or more control signals for the electric vehicle for each of one or more of the sequences of time slots based at least in part on the corresponding solution to the subproblem for that sequence of time slots.

The above-noted apparatus can be implemented, for example, at least in part in a cloud-based processing platform, and/or at least in part in one or more electric vehicles. For example, the apparatus can comprise multiple processing devices, with one such processing device implemented in a cloud-based processing platform, and another such processing device implemented in an electric vehicle. Numerous other arrangements are possible in other embodiments.

In some embodiments, a simulation-based optimization framework is configured to extend battery life and maximize productivity for a fleet of autonomous electric taxis (AETs) or other types of electric vehicles, illustratively by determining optimal operations for each of the electric vehicles in a designated operating time horizon divided into sequences of consecutive time slots. For each time slot, there are at least the following four possible operations: driving, cruising, parking, and charging, although additional or alternative operations can be used. To reduce the computational complexity, instead of solving the scheduling problem for the entire operating time horizon as a single problem, that problem is decomposed into a set of subproblems that are each built for one of the sequences of time slots. From an electric vehicle simulation model, which simulates the electric vehicle operation based on an optimal schedule determined as the solution to one of the subproblems for one of the sequences of time slots, precise battery status parameters, such as the state of charge, capacity loss and battery temperature, are derived and used as the initial values for the next subproblem for the next sequence of time slots.

Additionally or alternatively, illustrative embodiments disclosed herein can be implemented as at least part of an estimation system and/or recommendation system for a human driver or other user in an autonomous or semi-autonomous electric vehicle.

These and other illustrative embodiments can provide significant advantages over conventional approaches, including extended battery life and increased productivity across fleets of AETs or other types and arrangements of electric vehicles.

Illustrative embodiments disclosed herein include but are not limited to systems, methods, apparatus, processing devices, integrated circuits and computer program products comprising processor-readable storage media having software program code embodied therein.

### BRIEF DESCRIPTION OF THE FIGURES

FIG. 1 is a block diagram of an information processing system implementing a simulation-based optimization framework for controlling electric vehicles in an illustrative embodiment.

FIG. 2 shows an example set of time slots of a divided time horizon and corresponding possible operating states of an electric vehicle in an illustrative embodiment.

FIG. 3 is a block diagram showing an example electric vehicle simulator comprising an electric vehicle model and illustrating interaction between multiple submodels of the electric vehicle model in an illustrative embodiment.

FIG. 4 is a schematic diagram of an equivalent circuit model for a battery of an electric vehicle in an illustrative embodiment.

FIG. 5 shows plots of example SOC profiles of an original cycle and an equivalent cycle having the same average DOD in an illustrative embodiment.

FIG. 6 shows plots of cycle fading of original and equivalent cycles with different circulations in an illustrative embodiment.

FIG. 7 is a diagram of an example rolling horizon implementation with a look-ahead period in an illustrative embodiment.

FIG. 8 shows interaction between a scheduling optimization problem and a simulation model of an example simulation-based optimization framework for controlling electric vehicles in an illustrative embodiment.

FIG. 9 is a flow diagram of an example set of rule-based strategies within working hours in an illustrative embodiment.

FIG. 10 shows plots comparing performance of an example simulation-based optimization framework to rule-based strategies for cycle loss, calendar loss and battery lifespan in an illustrative embodiment.

FIGS. 11 and 12 show performance data under different scenarios for an example simulation-based optimization framework in illustrative embodiments.

FIG. 13 shows plots of sensitivity analysis of variable costs under different scenarios for an example simulation-based optimization framework in an illustrative embodiment.

FIG. 14 shows plots comparing performance of an example simulation-based optimization framework to a rule-based strategy for cycle loss, calendar loss and battery lifespan in an illustrative embodiment.

FIG. 15 shows plots illustrating performance of an example simulation-based optimization framework under different parking fee conditions in an illustrative embodiment.

FIG. 16 is a flow diagram of an example process for controlling electric vehicles using a simulation-based optimization framework in an illustrative embodiment.

### DETAILED DESCRIPTION

Illustrative embodiments disclosed herein can be implemented, for example, at least in part in the form of information processing systems comprising various arrangements of networked processing devices, such as computers and electric vehicles. For example, in some embodiments, a processing platform providing a simulation-based optimization framework for controlling electric vehicles in the manner disclosed herein is illustratively implemented within a cloud-based information processing system configured to generate control signals for delivery to the electric vehicles over one or more networks. Additionally or alternatively, at least portions of a simulation-based optimization framework as disclosed herein can be implemented in one or more electric vehicles, or in other system components such as electric vehicle charging infrastructure. It should be understood, however, that the disclosed embodiments of the invention are more generally applicable to a wide variety of other types of information processing systems and associated networks, processing devices or other components. Accordingly, the term “information processing system” as used herein is intended to be broadly construed so as to encompass these and other arrangements.

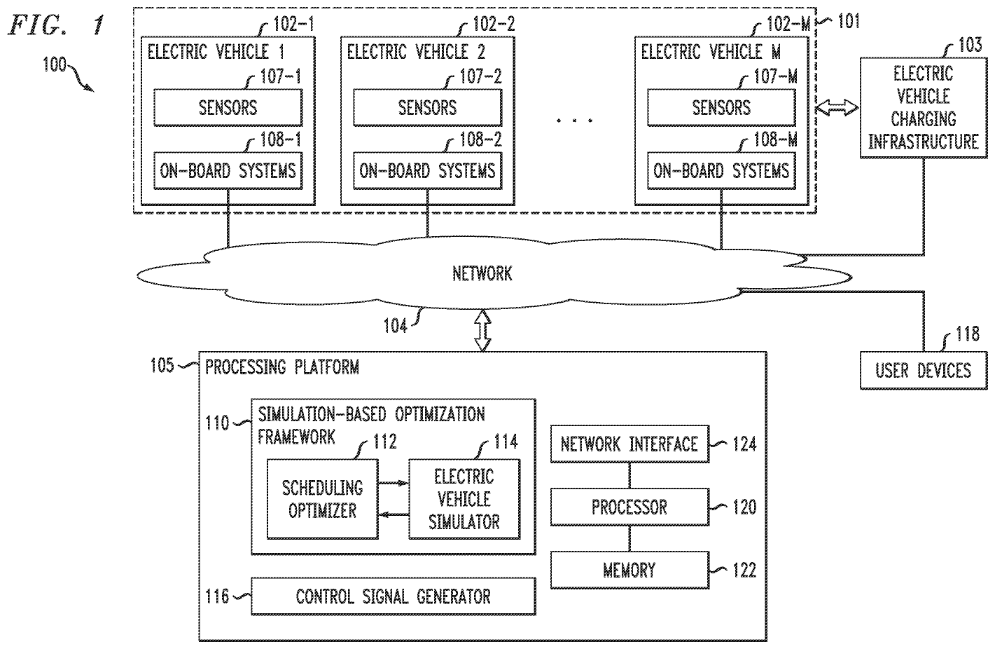

A number of illustrative embodiments will now be described in more detail with reference to FIGS. 1 through 16. It is to be appreciated that these particular embodiments, like others disclosed herein, are presented by way of illustrative example only, and should not be construed as limiting in any way.

Referring initially to FIG. 1, an information processing system 100 is configured with functionality for simulation-based optimization in controlling electric vehicles. The information processing system 100 includes a fleet 101 of electric vehicles 102-1, 102-2, . . . 102-M, collectively electric vehicles 102, where M is an integer greater than or equal to two. The electric vehicles 102 illustratively comprise AETs or other types of autonomous vehicles, although a wide variety of other types of electric vehicles, including non-autonomous or hybrid electric vehicles, in any combination, can be used in other embodiments. Although the electric vehicles 102 are assumed to be part of fleet 101 in the present embodiment, this is by way of example and not limitation, and the electric vehicles 102 in other embodiments can include alternative non-fleet arrangements of multiple such vehicles. Other examples of electric vehicles 102 include electric cars, electric trucks, electric vehicles for sharing, electric aircraft including electric drones, as well as electric ships and/or other electric vessels, in any combination. The term “electric vehicle” as used herein is therefore intended to be broadly construed.

Also, illustrative embodiments disclosed herein can be implemented as at least part of an estimation system and/or recommendation system for a human driver or other user in an autonomous or semi-autonomous electric vehicle.

The electric vehicles 102 include batteries that are rechargeable via electric vehicle charging infrastructure 103. The term “battery” as used herein is also intended to be broadly construed, so as to encompass, for example, a single battery, a battery pack comprising a combination of multiple individual batteries, and other arrangements of one or more batteries suitable for implementation in an electric vehicle. The electric vehicle charging infrastructure 103 is illustratively associated with at least one smart grid or other power grid of an electric utility or other energy service provider.

The electric vehicles 102 communicate over a network 104 with one another and with a processing platform 105 that is configured to control one or more aspects of the operation of the electric vehicles 102.

The network 104 can comprise, for example, a global computer network such as the Internet, a wide area network (WAN), a local area network (LAN), a satellite network, a telephone or cable network, a cellular network such as a 3G, 4G or 5G network, a wireless network implemented using a wireless protocol such as Bluetooth, WiFi or WiMAX, or various portions or combinations of these and other types of communication networks. Accordingly, references herein to a network such as network 104 are intended to be broadly construed so as to encompass arrangements involving a single network as well as arrangements involving multiple networks of potentially different types.

The electric vehicles 102 comprise respective sets of sensors 107-1, 107-2, . . . 107-M, collectively sensors 107, at least some of which are associated with respective on-board systems 108-1, 108-2, . . . 108-M, collectively on-board systems 108, of the electric vehicles 102. For example, as indicated above, the electric vehicles 102 comprise respective batteries, and those batteries are assumed to be part of respective battery systems in the on-board systems 108 of the electric vehicles 102. At least a subset of the sensors 107 are illustratively configured to monitor the batteries of the respective electric vehicles 102, such that corresponding battery status information can be provided by the electric vehicles 102 over the network 104 to the processing platform 105.

The processing platform 105 is assumed to comprise one or more processing devices each comprising a processor coupled to a memory. For example, the processing platform 105 can comprise multiple networked processing devices, such as a plurality of servers, possibly implemented at least in part utilizing virtual machines or other types of cloud-based virtualization infrastructure. The processing platform 105 can therefore be implemented as a cloud-based processing platform configured to receive battery status information from the sensors 107 of the electric vehicles 102.

In the present embodiment, the processing platform 105 implements a simulation-based optimization framework 110 that includes a scheduling optimizer 112 that interacts with an electric vehicle simulator 114. The processing platform 105 further comprises a control signal generator 116 configured to generate control signals for controlling various aspects of the operation of the electric vehicles 102 based at least in part on outputs generated by the simulation-based optimization framework 110 using its scheduling optimizer 112 and associated electric vehicle simulator 114.

The system 100 in this embodiment further includes a plurality of user devices 118 coupled to the network 104. The user devices 118 may comprise, for example, laptop computers, tablet computers or desktop personal computers, mobile telephones, or other types of computers or communication devices, as well as combinations of these and other types of processing devices. Such user devices 118 provide interfaces through which various users can interact with various components of the system 100, such as one or more of the electric vehicles 102 and the processing platform 105.

Each of the electric vehicles 102, processing platform 105 and user devices 118 of system 100 may be viewed as an example of what is more generally referred to herein as a processing device comprising a processor coupled to a memory. Illustrative embodiments disclosed herein implement simulation-based optimization functionality for controlling electric vehicles utilizing one or more such processing devices.

In operation, the processing platform 105 illustratively implements simulation-based optimization functionality for controlling at least one of the electric vehicles 102, via its scheduling optimizer 112, electric vehicle simulator 114 and control signal generator 116, in the following manner. The scheduling optimizer 112 illustratively formulates a scheduling optimization problem for controlling the operation of at least a given one of the electric vehicles 102 between a plurality of operating states based at least in part on battery status information of the electric vehicle, and decomposes the scheduling optimization problem into a plurality of subproblems associated with respective sequences of time slots.

It should be noted that terms such as “formulating” and “decomposing” as used herein are intended to be broadly construed, so as to encompass, for example, a wide variety of different arrangements by which the scheduling optimizer 112 can configure a particular instance of a scheduling optimization problem in accordance with particular parameters associated with one or more of the electric vehicles 102 and a corresponding operating environment within system 100, such as numbers of time slots per sequence, time slot durations, operating states and/or other parameters. For example, a scheduling optimization problem can be formulated and decomposed as recited in an entirely automated manner based at least in part on existing scheduling optimization problem templates or other data structures stored by the processing platform 105 and accessible to the scheduling optimizer 112. Formulation and decomposition of a scheduling optimization problem should therefore not be viewed as requiring involvement of a system administrator or other human user, although one or more such users may be involved in some aspects of formulation and decomposition, such as specifying particular parameters via a graphical user interface, possibly implemented on one or more of the user devices 118, in some embodiments disclosed herein. In addition, formulation and decomposition of a scheduling optimization problem as those terms are broadly used herein should not be viewed as requiring a particular sequential processing arrangement. For example, the formulation and decomposition may at least partially overlap with one another, with certain portions of the formulation being performed prior to the decomposition, possibly by specifying one or more general parameters for the scheduling optimization problem, while other portions of the formulation are performed substantially concurrently with corresponding portions of the decomposition into subproblems, possibly by specifying one or more specific parameters for each of one or more of the subproblems of the scheduling optimization problem.

The scheduling optimizer 112 interacts with the electric vehicle simulator 114 in generating solutions to the subproblems for the respective sequences of time slots. For example, in some embodiments, the electric vehicle simulator 114 illustratively generates updated values of the battery status information, for use by the scheduling optimizer 112 in solving the subproblem for each of one or more of the sequences of time slots, based at least in part on a solution to the subproblem generated by the scheduling optimizer 112 for a previous one of the sequences of time slots, with the updated values of the battery status information including one or more predicted values.

The control signal generator 116 generates one or more control signals for the electric vehicle for each of one or more of the sequences of time slots based at least in part on the corresponding solution to the subproblem for that sequence of time slots. For example, such control signals can comprise one or more control sequences for the electric vehicle, directing that electric vehicle to enter particular operating states for respective corresponding time slots in a sequence of time slots. Other types of control arrangements can be provided in other embodiments, and the term “control signal” is therefore intended to be broadly construed.

Operations similar to those described above can be implemented by the processing platform 105 for each of the electric vehicles 102, for example, to generate control signals for use in guiding, transitioning or otherwise controlling the electric vehicles between the plurality of operating states.

As mentioned above, the processing platform 105 in some embodiments is implemented at least in part as a cloud-based processing platform configured to communicate with the electric vehicles 102 over the network 104.

Numerous other arrangements of one or more processing devices can be used to implement simulation-based optimization functionality for controlling electric vehicles 102 in the manner disclosed herein. For example, portions of such functionality can be distributed over multiple processing devices, including one or more processing devices of the processing platform 105 and one or more processing devices in each of the electric vehicles 102.

In some embodiments, the plurality of operating states comprise at least a subset of a driving state, a cruising state, a charging state and a parking state, although it is to be appreciated that additional or alternative operating states can be used in other embodiments.

The operation of a given one of the electric vehicles 102 is illustratively controlled between different ones of the plurality of operating states for different ones of the time slots of a given one of the sequences of time slots in accordance with the solution to the corresponding subproblem, with the electric vehicle being assigned only one of the operating states within a given one of the time slots. For example, within a given one of the time slots, the electric vehicle is illustratively assigned to a particular one of the driving state, the cruising state, the charging state and the parking state.

The electric vehicle simulator 114 is illustratively configured to generate updated values of the battery status information at designated time intervals each having a duration that is substantially less than that of a given one of the time slots.

Additionally or alternatively, the electric vehicle simulator 114 takes as at least a portion of its inputs, for use in generating the updated values of the battery status information, one or more of (i) sensor readings from the electric vehicle, (ii) environmental readings associated with the electric vehicle, (iii) driving history information of the electric vehicle and (iv) predicted demand for the electric vehicle. Other types of inputs can be applied to the electric vehicle simulator 114 in other embodiments.

In some embodiments, the electric vehicle simulator 114 is configured to generate updated values of the battery status information that are applied as inputs to a first one of the subproblems in the scheduling optimizer 112 for a first one of the sequences of time slots. The electric vehicle simulator 114 is illustratively further configured to receive from the scheduling optimizer 112 a solution to the first subproblem for the first sequence of time slots and to generate, based at least in part on the received solution to the first subproblem, updated values of the battery status information that are applied as inputs to a second one of the subproblems in the scheduling optimizer 112 for a second one of the sequences of time slots.

A given such solution generated by the scheduling optimizer 112 for the first subproblem illustratively comprises a decision sequence specifying a sequence of operating states of the electric vehicle for the first sequence of time slots, although other types of solutions can be generated by the scheduling optimizer 112 for respective ones of the subproblems in other embodiments.

In some embodiments, the electric vehicle simulator 114 is configured to receive from the scheduling optimizer 112 solutions to respective additional ones of the subproblems for respective additional ones of the sequences of time slots and to iteratively generate, based at least in part on the received solution to one of the additional subproblems, updated values of the battery status information that are applied as inputs to a next one of the additional subproblems in the scheduling optimizer 112 for a next one of the sequences of time slots.

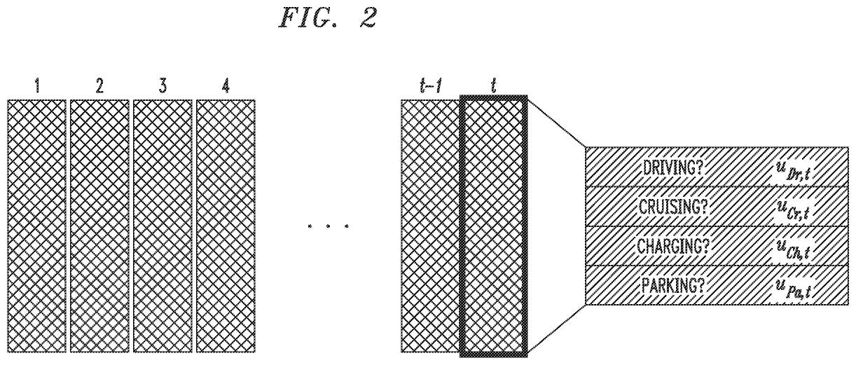

The sequences of time slots are illustratively part of respective multiple instances of an iterative planning horizon, with the multiple instances of the iterative planning horizon collectively defining an operating time horizon corresponding to a lifespan of a battery of the corresponding electric vehicle. An example of such a set of time slots is illustrated in FIG. 2, and described in more detail elsewhere herein.

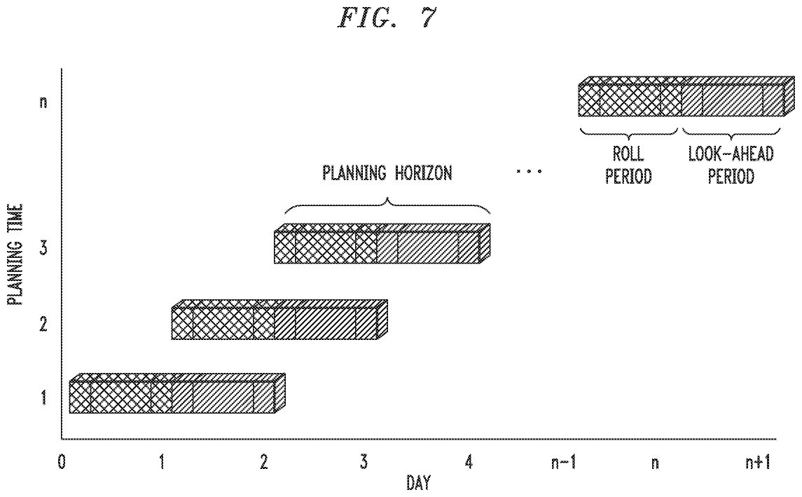

In some embodiments, at least one of the multiple instances comprises a roll period portion and a look-ahead period portion, as will be described in more detail below in conjunction with the illustrative embodiment of FIG. 7.

The above-noted battery status information illustratively comprises one or more of state of charge, voltage, capacity loss and temperature, although additional or alternative types of battery status information can be used in other embodiments.

The above-noted one or more predicted values that are part of the updated values of the battery status information in some embodiments illustratively comprise at least one of remaining life, state of health, capacity loss, power, voltage and current, although it should again be noted that additional or alternative values can be used in other embodiments.

Additionally or alternatively, the one or more predicted values in some embodiments comprise one or more predicted values of battery status information for at least a portion of each of one or more sets of time slots, such as future time slots or other time slots utilized in planning operations.

In some embodiments, the scheduling optimization problem is formulated by the scheduling optimizer 112 to maximize one or more performance measures of at least a given one of the electric vehicles 102 subject to one or more state of charge constraints of a battery of the electric vehicle. By way of example, in embodiments in which the electric vehicles 102 comprise AETs, the one or more performance measures can comprise economic performance measures, such as total profit, revenue, operating margin, etc. A wide variety of additional or alternative performance measures can be used, including, for example, demand fulfillment rate, total charging time, total idle time, total fleet usage, etc. The term “performance measure” as used herein is therefore intended to be broadly construed.

Also, terms such as “optimize” and “maximize” as used herein are intended to be broadly construed, and should not be viewed as requiring achievement of any particular mathematical optimum value or maximum value.

As indicated previously, the processing platform 105 comprises at least one processing device, illustratively including a processor 120, a memory 122 and a network interface 124 as shown. The processor 120 is assumed to be operatively coupled to the memory 122 and to the network interface 124, for example, via one or more system buses or other interconnection arrangements.

The processor 120 may comprise, for example, a microprocessor, an application-specific integrated circuit (ASIC), a field-programmable gate array (FPGA) or other programmable logic circuit, a central processing unit (CPU), a tensor processing unit (TPU), a graphics processing unit (GPU), an arithmetic logic unit (ALU), a digital signal processor (DSP), or other similar processing device component, as well as other types and arrangements of processing circuitry, in any combination. At least a portion of the simulation-based optimization functionality for controlling electric vehicles 102, provided by one or more processing devices as disclosed herein, can be implemented using such circuitry.

For example, in some embodiments, such as one or more embodiments in which the simulation-based optimization functionality is implemented primarily in processing platform 105 in a manner similar to that illustrated in FIG. 1, the processor 120 may comprise one or more graphics processor integrated circuits. Such graphics processor integrated circuits are illustratively implemented in the form of one or more GPUs. Accordingly, in some embodiments, system 100 is configured to include a GPU-based processing platform, illustratively implemented in the cloud. For example, such a GPU-based processing platform can be cloud-based configured to implement simulation-based optimization functionality for processing data associated with a large number of electric vehicles 102. Other embodiments can be implemented using similar arrangements of one or more TPUs.

Numerous other arrangements are possible. For example, simulation-based optimization functionality as disclosed herein can be distributed across the processing platform 105 and one or more of the electric vehicles 102, possibly with the scheduling optimizer 112 being implemented on the processing platform 105 and the electric vehicle simulator 114 being implemented within the electric vehicle. As another example, in some embodiments, simulation-based optimization functionality can be implemented primarily on one or more of the electric vehicles 102, utilizing one or more processors of each such electric vehicle. Such embodiments illustratively provide “on-board” implementation of simulation-based optimization functionality within the electric vehicles 102.

The memory 122 stores software program code for execution by the processor 120 in implementing portions of the functionality of the processing device. For example, at least portions of the functionality of the scheduling optimizer 112, the electric vehicle simulator 114 and/or the control signal generator 116 of the processing platform 105 can be implemented using program code stored in memory 122.

A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, flash memory, read-only memory (ROM), magnetic memory, optical memory, or other types of storage devices in any combination.

Articles of manufacture comprising such processor-readable storage media are considered embodiments of the invention. The term “article of manufacture” as used herein should be understood to exclude transitory, propagating signals.

Other types of computer program products comprising processor-readable storage media can be implemented in other embodiments.

In addition, illustrative embodiments may be implemented in the form of integrated circuits comprising processing circuitry configured to implement processing operations associated with simulation-based scheduling optimization for controlling the electric vehicles 102 in system 100. For example, at least a portion of the simulation-based scheduling optimization functionality of system 100 is illustratively implemented in at least one simulation-based scheduling optimization integrated circuit or other type of integrated circuit of at least one processing device.

The network interface 124 is configured to allow the processing device to communicate over the network 104 with other system elements, such as the electric vehicles 102, the electric vehicle charging infrastructure 103 and the user devices 118, and may comprise one or more conventional transceivers.

It is to be appreciated that the particular arrangement of components and other system elements shown in FIG. 1 is presented by way of illustrative example only, and numerous alternative embodiments are possible. For example, other embodiments of information processing systems can be configured to implement simulation-based optimization functionality of the type disclosed herein.

Additional illustrative embodiments will now be described with reference to FIGS. 2 through 16.

In some embodiments to be described, a simulation-based optimization framework is configured to maximize the economic performance of an autonomous electric taxi (AET), which can provide ride services for all day, automatically pick-up and drop-off the passengers, recharging and determine action in idle time, with consideration of the impact of action in battery fading and battery's state of charge (SOC). Further, due to the driverless technology, there is no labor cost of the driver.

Scheduling can affect the performance and lifespan of the AET. For example, the charging strategy has an impact on the cost by affecting the lifespan of the battery. Most studies focus on the whole lifespan of the electric vehicle from the environmental and economic perspectives. These studies mainly consider individual use of electric vehicles. On the basis of these previous works, further studies approach the electric vehicle from the optimization perspective, especially focusing on the interaction between the electric vehicle and the power grid. Most studies consider the case where a group of electric vehicles need to be charged from the same station and each electric vehicle needs to reach a certain level of SOC after charging. However, a fixed charging target would hinder the operation flexibility. To address this problem, a recent study proposed an optimal scheduling algorithm for the charging station. Due to the growing market adoption of electric vehicles, the charging station would become more accessible. Therefore, instead of optimizing the benefit of the aggregator, the grid, and the electric vehicle as a group, some studies focused on the economic benefits of a single electric vehicle.

These studies aimed to maximize the profit by finding the optimal charging time slot with a constant battery fading rate. However, an AET has much more mobility and opportunities to maximize profit, which requires more than finding the optimal charging schedule. Other factors, such as the customer pickup rate and the operations during the idle time, will also affect the profit of the AET. Yet, solving the optimal scheduling problem for an AET through its operating time horizon by an integrated optimization problem is challenging. Battery behaviors, such as the voltage drop and capacity fading, are nonlinear and make the optimization problem hard to solve for a time horizon covering the battery's lifetime (usually multiple years). Therefore, the moving horizon approach can be applied to decompose the whole problem across the planning time horizon into a series of subproblems. Yet, this approach raises a concern on solution accuracy. For AETs, some parameters, such as battery degradation and temperature's impact on the state of charge, change slowly over time. To reduce the computational complexity, these values can be assumed as fixed values for a short time period. However, to capture their long-term change, these values are updated between each subproblem by the electric vehicle simulation model. This simulation model uses input parameters from optimal scheduling, driving pattern, and ambient temperature, and determines the initial values and parameters for the next optimal scheduling optimization problem by simulating the AET's behavior with a precision of one second. Therefore, an electric vehicle simulation model is integrated to provide more accurate estimations of these parameters and battery status for the scheduling problem.

Some embodiments disclosed herein provide a simulation-based optimization framework for an AET, illustratively deployed in an urban setting, which can automatically and economically provide ride services with consideration of battery capacity loss. Unlike existing methods, we consider numerous aspects that will affect the economic performance of the AET, including the fixed operating expenses, electricity cost, parking cost, depreciation cost for parts besides battery and battery cost. Because the battery replacement criterion is directly relative with its capacity loss, the battery cost is listed separately from depreciation cost for parts and is linearized based on the capacity loss. By dividing the whole planning horizon into a series of fixed time slots and applying the moving horizon approach, the optimization model is formed to account for the AET's optimal charging, ride pickup and operations in idle time.

Additionally, because the scheduling optimization problem calculates the battery status at each time slot and the battery behaviors are continuous, the battery status derived from the optimization problem is not precise and cannot be used as the initial values for the next optimization problem. The framework includes an electric vehicle simulation for updating the initial values and parameters, such as the battery information and temperature effect through executing the optimal scheduling decision. The optimization problem and simulation model are coupled through simulation of the optimal scheduling and updated initial values and parameters. By solving the subproblem for a given period, the optimal scheduling decision is determined and executed by the AET operation simulation model. The next subproblem takes the simulation result as the initial values and parameters.

This process continues until the AET reaches the end of the operating time horizon, which is defined as the battery lifespan in illustrative embodiments. For the electric vehicle, the battery lifespan is defined as the maximum working time before the battery reaches its replacement criterion, which is losing 20% of its nominal capacity. A case study of an AET operated in New York City (NYC) is described herein to quantify the economic performance of an example simulation-based optimization framework as disclosed herein, with consideration of the past taxi ride data, parking cost, electricity price, missed ride penalty, ambient temperature, and urban driving cycle by comparing with two rule-based strategies. Moreover, a sensitivity analysis of parking cost, electricity price, missed ride penalty, cycle fade, and calendar fade on AET's economic performance is conducted.

Some embodiments provide an integrated framework of an electric vehicle simulation model and an optimal AET scheduling model for maximizing the AET's economic performance through the rolling horizon implementation for the AET operations.

Additionally or alternatively, illustrative embodiments incorporate battery behaviors, including the battery capacity loss and voltage, into the economic scheduling optimization problem. In particular, the nonlinear behavior of the battery capacity loss, including the cycle loss and calendar loss, are considered simultaneously in the simulation-based optimization framework for AETs.

Example Problem Statement

In some embodiments, we maximize the operating profit of an AET deployed in an urban area by considering the ride request, four possible operations and their impact on battery status, parking cost, and electricity cost in a scheduling optimization problem, and ambient temperature, speed profile of urban driving cycle, battery status including the discharge, charge and capacity loss, active thermal control of the battery pack, and thermal behavior of the vehicle in a simulation model.

The objective of the optimal scheduling problem is to maximize the AET's economic performance by determining the optimal operations while subject to the state of charge constraints of the battery.

In some embodiments, a planning time horizon is partitioned into a set of consecutive time slots, i.e., slot=1, 2, . . . , N, where Nis a positive integer. This time horizon illustratively extends to the end of the battery's life, which is defined by the replacement criteria, which may be, for example, the battery losing 20% of its nominal capacity, although additional or alternative criteria can be used.

Given the planning horizon, ride request information, the initial battery's status, changes of SOC for four possible operations, electricity price, parking rates and missed ride penalty, the optimal scheduling problem is solved to determine the optimal operations in each time slot to maximize the economic performance. After solving the optimal scheduling problem, the optimal scheduling is fed into the simulation model to generate initial values and parameters for the next optimization problem. The battery behaviors, such as the SOC and voltage, are continuous, but in the optimization model these values are calculated at each time slot which are not precise. Therefore, a simulation model is utilized to provide precise battery status information, such as the state of charge, capacity loss and battery temperature, and serve as the initial values for the optimization model. A rolling horizon approach is illustratively applied in which only the optimal scheduling for the roll period is used. To reduce the problem's complexity, we utilize the following assumptions in some embodiments:

1. Within the time horizon, the AET operates 24 hours per day with the help of driverless technology which can operate without interruption.

2. Only four operations, namely, driving, cruising, charging and parking, are considered in some embodiments, although other embodiments can utilize additional or alternative operations. For example, the AET can have other operations such as maintenance. However, compared with the four operations mentioned previously, other operations typically represent only a small fraction of time within the time horizon, for example, because the AET requires little to no regular maintenance. Therefore, other operations are neglected in some embodiments to be described in detail below.

3. The total cost includes the electricity cost, parking cost, battery cost due to capacity loss, vehicle depreciation and fixed operating cost, including the insurance, affiliation fees and others.

4. The cost of the battery is linearly scaled with the capacity lost.

5. The passenger weight is ignored because on average there are 1.66 passengers in a trip which is negligible compared to the vehicle mass.

It is to be appreciated that the above assumptions are exemplary only, and need not apply in other embodiments.

Based on the optimal scheduling decisions for the roll period, environmental temperature and driving pattern, the electric vehicle simulation model performs a detailed simulation of the AET to provide the battery's SOC, the average quadratic voltage, the capacity fade, and the impact of temperature on SOC for the optimization problem. For accurate and detailed simulations, some assumptions for the battery's thermal management system are made, as follows, although again such assumptions need not apply in other embodiments:

1. The simulation neglects the temperature gradient within the cell, and instead assumes that the temperature in the center of the cell is the same as the temperature on the surface of the cell. Although some studies point out that there exists a temperature gradient inside the cell in both radial and axial directions caused by the layered structure within the cell and the position of connectors, the generated heat is negligible when the current ratio is small. For an AET, high discharging current usually lasts only for a short time.

2. The simulation model also assumes that the temperature is uniform within the battery pack, which means that the temperature of cells near the coolant entrance is the same as temperature of cells near the coolant exit.

Example Scheduling Optimization Problem

Objective

FIG. 2 shows an example divided time horizon and four possible operations for an electric vehicle. Such operations may be viewed as examples of what are more generally referred to herein as “possible operating states” of an electric vehicle. It is assumed in this embodiment that the electric vehicle comprises an AET, which has operations of driving, charging, and cruising, as well as an additional operation of parking to minimize energy consumption. Therefore, as illustrated in FIG. 2, for each of a plurality of time slots, the AET is illustratively assigned one operation from four possible options, including driving, cruising, charging, and parking. In the driving operation, the AET drives with a nominal speed on the road. In the cruising operation, the AET moves with reduced speed relative to the driving operation, in order to save electricity and parking costs. The AET is charged during the charging operation. For the parking operation, the AET is turned off and no current passes through the battery, resulting in zero cycle fading, while the calendar fading continues. The AET is controlled between these operations based at least in part on one or more control signals, such as control signals generated by the control signal generator 116 in the processing platform 105 of FIG. 1. The control signals associated with a sequence of time slots illustratively define a control sequence for the AET.

Let binary 0-1 variable u_{i,t} denote the decision variable for the four operations at time slot t. The goal of the scheduling optimization problem in this embodiment is to maximize the profit of the AET before the battery needs to be replaced, by identifying the optimal control sequence U_{N}*={u_{i,1}*, u_{i,2}*, . . . , u_{i,N}*}. The total profit of an AET generated within a battery's lifespan can be calculated as follows:

Z=R−C_{Bat}−C_{OP}−D (1)

where R is the total revenue of an AET collected within a battery's lifespan, C_{OP} is the total operating cost, including the parking cost and the electricity cost, C_{Bat} is the battery cost, and D represents other costs including the depreciation of parts besides the battery and fixed operating costs. For a manually-driven taxi, the labor cost of a driver is responsible for a large fraction of the operating costs. However, as a driverless vehicle, the AET does not incur labor cost of a human driver. During the operation of an AET, both C_{OP} and R are functions of the control sequence. Therefore, the objective function for the optimization problem, which determines the optimal control sequence through a battery's lifespan, can be expressed as follows:

$${Z}^{*} = {arg max}_{{U}_{N}} R ( {U}_{N} ) - {C}_{B a t} - {C}_{O P} ( {U}_{N} ) - D \qquad ( 2 )$$

Ideally, the optimal solution can be acquired by solving the optimization problem given in Eq. (2) directly. However, it is difficult to solve such a problem directly for at least the following reasons. First, the time horizon N, which represents the service life of the battery, could be quite long compared to the length of a time slot. Generally, for a typical AET, the battery can last for a few years, so it requires a control sequence of the AET over the battery's lifetime, which is unknown and depends on the capacity fading of the battery. Second, this problem is essentially a mixed-integer programing problem that is often NP-hard, because binary variables are involved for modeling the selection of operational modes in each time slot. Moreover, the size of the problem could be very large. Although the lifespan of the battery depends on the battery's design, chemistry and other factors, a typical battery can last for three years. If we consider 20 minutes per time slot, with the four decision variables for driving, cruising, charging and parking, there are 315,360 binary variables for an AET with a typical lifespan of three years. Therefore, instead of focusing on maximizing the profit within the lifespan of the battery, illustrative embodiments maximize the profit within a certain timespan T to reduce the number of decision variables, thus making the problem tractable.

The timespan T should be chosen carefully. If Tis too long, the subproblems are large and may require an excessively long solving time. In contrast, when T is small, the total number of subproblems increases, which may have a negative impact on the overall performance.

The optimal control sequence can be acquired by solving a sequence of subproblems for T={T₁, T₂, . . . , Tᵢ}. Therefore, Eq. (2) can be cast as,

$${Z}_{T}^{*} = {arg max}_{{u}_{T}} {R}_{T} ( {u}_{T} ) - \frac{{C}_{loss , T} ( {u}_{T} )}{{C}_{retired}} {C}_{Bat} - {C}_{OP , T} ( {u}_{T} ) - {D}_{T} \qquad ( 3 )$$

where R_{T} is the revenue generated over the timespan T, C_{loss,T} is the capacity loss, C_{OP,T} is the operating cost, u_{T} is the control sequence in timespan T, C_{retired} is the retirement threshold for capacity loss, and D_{T} is the other fees generated within timespan T. The battery needs to be replaced when it loses C_{retired} which is set to 20% in this embodiment in accordance with the example end-of-life criteria.

State of Charge (SOC)

The four operations introduce different SOC drops, which can be denoted as follows:

OP_{T}={d,cr,p,c} (4)

d<cr<0=p<c (5)

where d, cr, p, and c represent the SOC change for driving, cruising, parking and charging, operations, respectively. We note that driving and cruising operations both use the electric power stored in the battery and decrease its SOC, so both d and cr have non-positive values as shown in Eq. (5). For the parking operation, the vehicle is completely shut down, so no more power is drained from the battery pack and the SOC remains unchanged. As for charging, the total SOC change is positive for a charging slot.

In most of the normal operational range of the battery, the battery behavior can be modeled as a linear process. Therefore, in each subproblem, which solves for the optimal operations over the timespan T, d, cr, p, and c are constants and represent the SOC change for driving, cruising, charging and parking, respectively. Therefore, the SOC at different time slots can be represented as follows:

$$S O {C}_{t} = S O {C}_{t - 1} + {\sum }_{i} {u}_{i , t} O {P}_{T} \qquad ( 6 )$$

$${\sum }_{i} {u}_{i , t} = 1 \qquad ( 7 )$$

where u_{i,t} is the binary variable for operation i at time slot t. Eq. (6) represents the SOC relationship between two consecutive time slots; Eq. (7) shows that only one operation can be performed in each time slot.

Due to battery safety concerns, it is assumed that overcharging and overdischarging are not permitted in illustrative embodiments. The SOC can only range from 0 to 1. However, in some embodiments, to avoid draining the battery completely, we set a minimum threshold a, to act as a backup power to deal with certain emergency cases. Moreover, the battery's behavior is no longer linear in the low SOC region. Therefore, the value of a can be chosen based on the SOC vs. voltage curve. The range of SOC is given in the following constraint:

0<a≤SOCₜ≤1 (8)

Revenue

As previously mentioned, the time horizon is partitioned into a set of consecutive time slots, illustratively with identical intervals. It is assumed that ride requests are associated with selected ones of the time slots. For a valid pickup to occur, the AET needs to be operating in driving mode, and there should be a ride request in the corresponding time slot. On the other hand, customer satisfaction is important and is directly related to the ride pickup rate. Therefore, a missed ride penalty is introduced. For a given time horizon T, the revenue can be represented as follows:

$${R}_{T} = F {\sum }_{t}^{T} {S}_{t} {u}_{Dr , t} - P e {\sum }_{t}^{T} {S}_{t} ( 1 - {u}_{Dr , t} ) , {S}_{t} ∈ \{ 0 , 1 \} \qquad ( 9 )$$

where Sₜ represents the possible ride request in time slot t, u_{Dr,t} is the driving decision variable for time slot t, F is the fare to be collected from a valid ride, and Pe is the penalty for a missed ride.

Battery Cost

There are two types of aging behaviors for a battery that are considered in illustrative embodiments, namely, calendar aging and cycle aging. A number of methods are used for modeling the aging behaviors of the Li-ion batteries. In some embodiments, to simulate the capacity fading behavior of a Nickel Manganese Cobalt (NMC) Li-ion battery, which is widely used in electric vehicles, we adopt aging models in which the calendar aging and cycle aging are calculated as follows:

$${C}_{loss , Cal} = ( {C}_{1} \cdot {V}^{B a t} - {C}_{2} ) \cdot {e}^{- \frac{{C}_{3}}{{T}^{Bat}}} {t}^{0.75} \qquad ( 10 )$$

$${C}_{loss , Cycle} = \sqrt{Q} ( {C}_{4} \cdot {( ϕ V - {C}_{5} )}^{2} + {C}_{6} + {C}_{7} Δ D O D ) \qquad ( 11 )$$

where t is the time in unit of day and T_{Bat} is the temperature of the battery in units of Kelvin, ΦV is the quadratic mean of voltage, ΔDOD is the average depth of discharge (DOD), Q is the throughput, and C₁ to C₇ are constants. Additional details regarding these aging models can be found in J. Schmalstieg et al., “A holistic aging model for Li(NiMnCo)O₂ based 18650 lithium-ion batteries,” Journal of Power Sources, 257:325-34, July 2014, which is incorporated by reference herein in its entirety.

The capacity loss within the timespan T can be represented by the equation below:

C_{loss,T}=C_{loss,end}−C_{loss,begin} (12)

where C_{loss,begin} is the capacity loss at the beginning of timespan T and the C_{loss,end} is the capacity loss after the timespan T To reflect the selected operation's impact on the capacity loss, the capacity fading behavior is calculated at each time slot. Eq. (10) can be differentiated to estimate the fading in each time slot as follows:

$${C}_{t}^{loss , Cal} = {[ {( \frac{{C}_{t - 1}^{l oss , Cal}}{{α}_{t}} )}^{\frac{1}{0.75}} + S L ]}^{0.75} \qquad ( 13 )$$

$${α}_{t} = ( {C}_{1} \cdot {V}_{t}^{Bat} - {C}_{2} ) \cdot {e}^{- \frac{{C}_{3}}{{T}^{Bat}}} \qquad ( 14 )$$

where Cₜ^{loss,Cal} is the calendar loss in time slot t, SL is the length of each time slot, and T^{Bat} is the battery temperature. To avoid thermal runaway and ensure safety, most of the electric vehicles install active or passive cooling systems to the battery pack for temperature management, as will be discussed elsewhere herein. Therefore, in some embodiments, the temperature of the battery is assumed to be a constant within the time horizon T. Vₜ^{Bat} is the average battery voltage in time slot t, which can be calculated as follows:

$$V = exp ( {\sum }_{k = 0}^{b} {a}_{k} {ln}^{k} ( SOC ) ) \qquad ( 15 )$$

where the values of parameters aₖ are estimated by fitting the experimental data with a sixth-order polynomial function, corresponding to b=6 in Eq. (15), and are provided for discharging and charging states, as described in more detail in Y. Cao et al., “Multi-timescale Parametric Electrical Battery Model for Use in Dynamic Electric Vehicle Simulations,” IEEE Transactions on Transportation Electrification, 2:432-42, December 2016, which is incorporated by reference herein in its entirety.

Cycle fade, which is highly dependent on the AET's operations in the corresponding time slot, can be calculated by differentiating Eq. (11) as follows:

$${C}_{t}^{loss , Cycle} = {{β}_{t} [ {( \frac{{C}_{t - 1}^{loss , Cycle}}{{β}_{t}} )}^{2} + Δ {Q}_{t} ]}^{0.5} \qquad ( 16 )$$

$$β = {C}_{4} \cdot {( {ϕV}_{t} - {C}_{5} )}^{2} + {C}_{6} + {C}_{7} Δ D O {D}_{t} \qquad ( 17 )$$

where Cₜ^{loss,Cycle} is the cycle loss in time slot t, and ΔDOD is the average depth of discharge. ΔQₜ is the total throughput within the time slot t and can be calculated by:

$$Δ {Q}_{t} = {C}^{R a t e d} {\sum }_{i} {u}_{i , t} \vert {OP}_{j} \vert \qquad ( 18 )$$

where Cₜ^{Rated} is the rated capacity of a cell. ϕVₜ is the quadratic average voltage of the battery at time t, and can be expressed as:

$${ϕV}_{t} = \sqrt{\frac{{ϕV}_{t - 1}^{2} ( t - 1 ) + {( {V}_{t}^{Bat} )}^{2}}{t}} \qquad ( 19 )$$

By definition, the DOD is the depth of discharge from the fully charged status. However, the DOD is hard to measure, because the battery does not always discharge from 100%. Therefore, ΔDOD is approximated using the following equations:

$$Δ D O {D}_{t} = Δ D O {D}_{t - 1} \cdot ( 1 - {u}_{Ch , t} ) + \frac{{S}_{total , t} \cdot {u}_{Ch , t}}{2 \cdot {n}_{valid , t}} \qquad ( 20 )$$

$${S}_{total , t} = {S}_{total , t - 1} + \vert {\sum }_{i} {u}_{i , t} {OP}_{j} \vert \qquad ( 21 )$$

$${n}_{valid , t} = {n}_{valid , t - 1} + {u}_{Ch , t} ( 1 - {u}_{Ch , t - 1} ) \qquad ( 22 )$$

where ΔDODₜ is the average depth of discharge in time slot t, Sₜ is the total SOC change and n_{valid,t} is the total valid charge by time slot t.

After calculating the battery's fading behavior at each time slot, Eq. (12) can be reformulated into:

C_{loss,T}=C_{loss,Cal,end}−C_{loss,Cal,begin}+C_{loss,Cycle,end}−C_{loss,Cycle,begin} (23)

where C_{loss,Cal,end} and C_{loss,Cycle,end} are the calendar loss and cycle loss for the last time slot of the timespan T. C_{loss,Cal,begin} and C_{loss,Cycle,begin} are the initial calendar loss and cycle loss.

Operating Cost

Unlike ICE vehicles, the AET is powered by electricity, so the energy cost is one of the major contributors to the AET's daily operating cost. Therefore, for a timespan T, the total electricity cost can be calculated as follows:

$${P}_{E , T} = e \cdot r \cdot {C}^{Rated} \cdot {N}^{P a c k} \cdot SL \cdot {\sum }_{t}^{T} {u}_{Ch , t} \cdot {V}_{t}^{Bat} \qquad ( 24 )$$

where P_{E,T} is the total electricity cost within the timespan T, e is the unit price of electricity, r is the charging ratio, N^{Cell} is the total number of cells within the battery pack, and u_{Ch,t} is the charging decision variable in time slot t.

From the perspective of extending the battery life and saving energy, the AET can adopt an approach similar to that of a human driver that parks to wait for a rider. Therefore, in some embodiments, the option of parking is introduced and the impact of parking rate on the economic performance of an AET is considered. The parking cost generated within the timespan T can be expressed as

$${P}_{P , T} = P a {\sum }_{t}^{T} {u}_{Pa , t} \qquad ( 25 )$$

where P_{P,T} is the total parking cost for timespan T, Pa is the parking rate for each time slot which is assumed to be a constant, and u_{Pa,t} is the charging decision variable in time slot t. Therefore, given Eqs. (24) and (25), the total operating cost of a given timespan Tis:

C_{OP,T}=P_{E,T}(u_{T})+P_{P,T}(u_{T}) (26)

Example Problem Formulation

The optimization problem in some embodiments includes four groups of constraints, namely, the SOC constraints, the revenue constraints, the battery cost constraints, and the operating cost constraints. Binary variables account for the operation mode selection in each time slot. All other variables are continuous variables. The objective function is the total profit generated within the fixed planning timespan T which constitutes the battery lifespan. The battery fading process is a nonlinear process, so the resulting problem is a mixed-integer nonlinear program (MINLP) and is summarized below.

$$\begin{matrix}max & {R}_{T} ( {u}_{T} ) - \frac{{C}_{loss , T} ( {u}_{T} )}{{C}_{retired}} {C}_{Bat} - {C}_{OP , T} ( {u}_{T} ) - {D}_{T} \\ s . t . & SOC constraints , Eqs . ( 6 ) - ( 8 ) ; \\ & revenue constraints , Eq . ( 9 ) ; \\ & battery cost constraints , Eqs . ( 13 ) - ( 23 ) ; \\ & operating cost constraints , Eqs . ( 24 ) - ( 26 ) .\end{matrix}$$

The initial state of charge, SOC₀, the change of SOC for four operations, OP_{T}, the initial quadratic average voltage, ϕV₀, and the capacity fade data, C_{loss,Cal,begin} and C_{loss,Cycle,begin}, are acquired from the electric vehicle simulation model, which is described below.

Example Simulation Model

In the following description, an example electric vehicle simulation model is introduced, as we have determined that coupling the electric vehicle simulation with the AET economic maximization problem provides accurate initial values and parameters for the scheduling optimization problem. In the scheduling optimization problem, the variables, such as the voltage, capacity fades and SOC, are calculated in each time slot (e.g., every 20 minutes), instead of at a finer time granularity (e.g., every second), to reduce the problem size. However, since the battery behaviors are continuous processes, updating the variables in each time slot may not be sufficiently precise and may lead to some difference between the real behaviors and calculated values, which will accumulate in the long term. To address this problem, these values in some embodiments are recalculated by the electric vehicle simulation model, which updates the variables at the finer time granularity (e.g., every second), after they are initially determined by the scheduling optimization problem.

There are existing studies on various types of electric vehicle models. However, these studies focus on the energy model and neglect many other factors, such as the battery temperature management. Therefore, these models may not be precise enough to simulate the electric vehicle for a long horizon with changing ambient temperature. Some embodiments herein therefore implement a simulation model for an electric vehicle with an NMC battery.

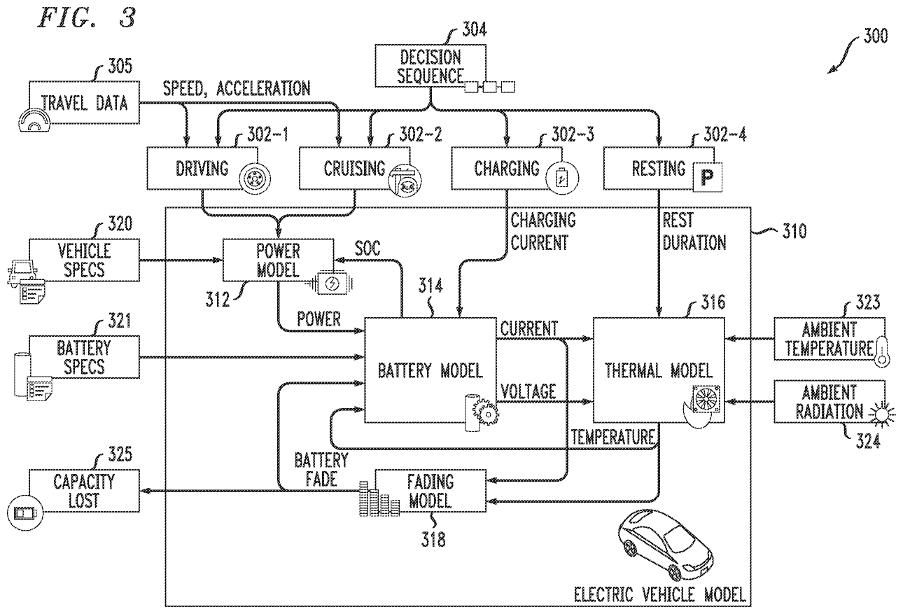

FIG. 3 shows an example implementation of an electric vehicle simulator 300 in an illustrative embodiment. The electric vehicle simulator 300 may correspond, for example, to at least a portion of the electric vehicle simulator 114 of FIG. 1. The electric vehicle simulator 300 assumes that an electric vehicle is operable in a particular one of four different operating states 302-1, 302-2, 302-3 and 302-4, corresponding to driving, cruising, charging and parking, respectively, in each of plurality of time slots of a decision sequence 304 generated by a scheduling optimizer such as scheduling optimizer 112 of FIG. 1. The parking state is also referred to herein as a resting state, or a parking/resting state.

The electric vehicle simulator 300 includes an electric vehicle model 310 that has four submodels, namely, a power model 312, a battery model 314, a thermal model 316, and a fading model 318. The electric vehicle simulator 300 operates on travel data 305 from the electric vehicle, such as speed and acceleration data associated with the driving and cruising states 302-1 and 302-2, which are applied to the power model 312 as shown. Other inputs to the electric vehicle model 310 include vehicle specifications (“specs”) 320 applied to the power model 312; battery specs 321 and charging current measurements from charging state 302-3, applied to the battery model 314; and rest duration from parking state 302-4 and environmental measurements of ambient temperature 323 and ambient radiation 324, applied to the thermal model 316. The interactions between the various submodels 312, 314, 316 and 318 are illustrated in the figure. The fading model 318 generates an output 325 indicative of battery capacity loss.

To obtain high fidelity and accurate simulation results, the fading information and SOC of the battery are calculated every second in this simulation model, although other time granularities can be used.

Power Model

The power model calculates the demanded power to accelerate or to maintain the current speed. This model takes the speed, acceleration, vehicle specifications, and SOC as inputs. The demanded power, Pₜ^{Driving}, is calculated as follows.

$${P}_{t}^{Driving} = \{ \begin{matrix}\frac{E}{{η}^{B 2 W}} & For {a}_{t} \geq 0 and {SOC}_{t - 1} > {SOC}^{Thershold} \\ {η}^{RB 2 B} E & For {a}_{t} < 0\end{matrix} \qquad ( 27 )$$

$$E = \frac{1}{2} {ρ}^{Air} {v}_{t}^{3} {C}^{Drag} {A}^{Front} + {m}^{V} {a}_{t} {v}_{t} + {C}^{RR} {m}^{V} {gv}_{t} \qquad ( 28 )$$

where SOC^{Thershold} is the cutoff SOC. To avoid over-discharge, once the SOC is below the threshold value, SOC^{Thershold}, the battery will automatically cutoff and the vehicle will stop running to protect the battery. To avoid this situation in the AET operation, SOC^{Thershold} is set to be lower than the threshold a mentioned previously. η^{B2W} is the efficiency between battery and wheel, η^{RB2B} is the efficiency between regenerative break and battery, ρ^{Air} is the air density, νₜ is the velocity at time t, C^{Drag} is the drag constant, A^{Front} is the front area, m^{V} is the vehicle mass, C^{RR} is the rolling resistance coefficient, and g is the gravitational acceleration.

Battery Model

After determining the demanded power, the current and voltage profiles are calculated by the battery model. Examples of battery models include mathematical models, electrochemical models, and equivalent circuit models (ECMs). Compared with the electrochemical models and mathematical models, the ECM provides a good balance between solution quality and computational efficiency. In the case of the ECM, the accuracy of the model can be improved by introducing more parallel resistance-capacitance networks. In some embodiments, since the model is used to characterize the capacity aging behavior of the battery over a long period, we utilize an ECM with multiple parallel resistance-capacitance networks, although other battery models can be used in other embodiments.

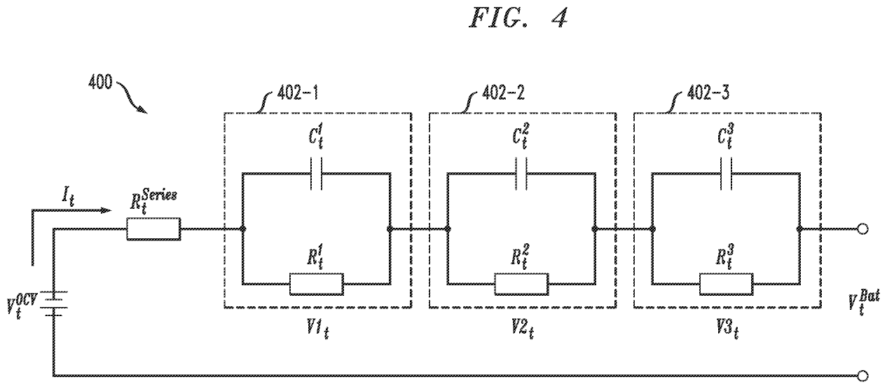

FIG. 4 shows a schematic of an example ECM for a battery 400 of a given one of the electric vehicles 102. The example ECM in this example illustratively includes three parallel resistance-capacitance networks 402-1, 402-2 and 402-3, although as indicated above, the accuracy of the model can be improved by introducing more parallel resistance-capacitance networks 402.

The battery output voltage at time t can be calculated as follow:

Vₜ^{Bat}=Vₜ^{OCV}−V1ₜ−V2ₜ−V3ₜ−IₜRₜ^{Series} (29)

where the Vₜ^{Bat} is the output voltage of the cell, Vₜ^{OCV} is the open circuit voltage, V1ₜ, V2ₜ and V3ₜ are the voltage drops across the parallel resistance-capacitance networks, and Rₜ^{Series} is the internal resistance. The values of V1ₜ, V2ₜ and V3ₜ can be expressed by the differential equation:

$$\begin{matrix}\frac{d V n}{d t} = - \frac{1}{{R}^{n} {C}^{n}} V n + \frac{1}{{C}^{n}} I , & n = 1 , 2 , 3\end{matrix} \qquad ( 30 )$$

The values of Vₜ^{OCV}, Rₜⁿ, Cₜⁿ and R^{Series} are functions of the SOC and can be calculated as follows:

$$\begin{matrix}{V}_{t}^{O C V} = exp ( {\sum }_{k = 0}^{6} {a}_{{V}^{OCV} , k} {ln}^{k} ( S O {C}_{t} ) ) \\ {R}^{Series} = exp ( {\sum }_{k = 0}^{6} {a}_{{R}^{Series} , k} {ln}^{k} ( S O {C}_{t} ) ) \\ \begin{matrix}{C}_{t}^{n} = exp ( {\sum }_{k = 0}^{6} {a}_{{C}^{n} , k} {ln}^{k} ( S O {C}_{t} ) ) , & n = 1 , 2 , 3\end{matrix} \\ \begin{matrix}{R}_{t}^{n} = exp ( {\sum }_{k = 0}^{6} {a}_{{R}^{n} , k} {ln}^{k} ( S O {C}_{t} ) ) , & n = 1 , 2 , 3\end{matrix}\end{matrix} \qquad ( 31 )$$

In the above-cited Y. Cao et al. reference, the values of parameters a_{V}^{ocν},ₖ, a_{R}^{Series},ₖ, a_{C}ⁿ,ₖ, and a_{R}ⁿ,ₖ are estimated by fitting the experimental data with sixth-order polynomial functions, and provided these parameters for discharging and charging states. The load current for each cell at time t can be calculated as follows:

$${I}_{t} = \{ \begin{matrix}\frac{{P}_{t}^{Driving} + {P}_{t}^{HVAC} + {P}_{t}^{A C}}{{V}_{t} {N}^{P a c k}} & Driving \\ {I}^{Charging} / {N}^{P a r a l l e} & Charging\end{matrix} \qquad ( 32 )$$

where Pₜ^{Driving} is the demanded power calculated by the power model, Pₜ^{HVAC} is the power consumed by the heating, ventilation, and air conditioning (HVAC) system, Pₜ^{AC} is the power consumed by the battery active cooling, N^{Pack} is the number of cells within the battery pack, and N^{Parallel} is the number of cells in parallel.

The SOC needs to be updated to keep track of the battery status. In this simulation, we reformulate the SOC calculation method proposed in the Y. Cao et al. reference to the following equation, so that the SOC can be calculated in each second.

$$S O {C}_{t} = S O {C}_{t - 1} - {F}_{{n}_{Cycle}} {F}_{{T}_{Bat}} {F}_{C - rate} \frac{{I}_{t}}{{C}_{rated}} \qquad ( 33 )$$

where C^{Rated} is the nominal capacity. The SOC is affected by the cycle number, battery temperature and current. Three factors F_{ncycle}, F_{TBat} and F_{C-rate}, are introduced in this function to correct the impact caused by capacity loss, battery temperature and current. Instead of using the linear interpolation to calculate the value of F_{ncycle}, it is calculated based on the cycle fade and calendar fade data.

Thermal Model

Compared with other vehicles, the battery electric vehicles have a large battery pack to provide a competitive travel range. The battery pack generates a considerable amount of heat during charging and discharging when the current is high (e.g., during fast charging and rapid acceleration). Moreover, to provide a high capacity battery pack within a limited volume, the battery pack has a compact design that mitigates the natural cooling effect. Although there are many studies on the thermal management of the battery pack, the number of electric vehicle simulation models with an active cooling system is limited. Therefore, to avoid the thermal runout, an active cooling system is added to this simulation model to ensure that the battery works within a safe temperature range. In illustrative embodiments, it is assumed that the active cooling system automatically turns on when the battery's temperature exceeds 35° C.

The battery temperature at time t can be calculated as follows:

$${T}_{t}^{B a t} = \{ \begin{matrix}{T}_{t - 1}^{B a t} + \frac{{Q}_{t}^{G e n} - {Q}_{t}^{T r a n s}}{{M}^{B a t}} & {T}_{t - 1}^{B a t} \geq 35 ° C . \\ {T}_{t - 1}^{B a t} + \frac{{Q}_{t}^{G e n} - {Q}_{t}^{T r a n s}}{{M}^{B a t} + {M}^{Liq}} & {T}_{t - 1}^{B a t} < 35 ° C .\end{matrix} \qquad ( 34 )$$

where Qₜ^{Gen} is the heat generation rate of the battery, Qₜ^{Trans} is the heat transfer rate either to or from the battery, Mₜ^{Bat} is the thermal mass of the battery, and M^{Liq} is the thermal mass of the liquid coolant within the battery pack.

All the cells are assumed to have the same electrical behavior and heat generation rate. The total heat generated by the battery pack can be calculated by summing all the heat generated from each cell:

\dot{Q}ₜ^{Gen}=N^{Module}Iₜ(Vₜ^{OCV}−Vₜ^{Bat}) (35)

The heat transfer rate to or from the battery can be calculated as follows:

$${Q}_{t}^{T r a n s} = \{ \begin{matrix}{Q}_{t}^{A C} + {Q}_{t}^{N C} & {T}_{t - 1}^{B a t} \geq 3 {5}^{∘} C . \\ {Q}_{t}^{N C} & {T}_{t - 1}^{B a t} < 3 {5}^{∘} C .\end{matrix} \qquad ( 36 )$$

where Qₜ^{AC} is the heat removed by the active cooling system that circulates the coolant through the battery banks, and Qₜ^{NC} is the heat transferred by the natural convection which is calculated using an approach similar to that described in J. Neubauer et al., “Thru-life impacts of driver aggression, climate, cabin thermal management, and battery thermal management on battery electric vehicle utility,” Journal of Power Sources, 259:262-75, August 2014, which is incorporated by reference herein in its entirety.

Fading Model

In reality, there is a temperature gradient within the battery pack leading to an unbalanced performance between each cell which will result in heterogeneously fading behaviors across the battery pack. However, the fading behavior is also uniform in illustrative embodiments because of the assumption of uniform temperature within the battery pack. Moreover, calculating each cell's fading behavior requires a complex thermal model. Therefore, instead of calculating every cell's aging behavior, we assume that the aging behaviors are the same among the cells. Only one single cell's aging behavior is simulated to represent the aging behavior of the whole battery pack. Different methods are used to model the aging behaviors of Li-ion batteries. As mentioned previously, some embodiments herein use a model as described in the above-cited J. Schmalstieg et al. reference. Eqs. (13), (14), (16), and (17) are designed to connect the fading behavior between two consecutive time slots. For the simulation model, which updates every second, we reformulate Eqs. (10) and (11) as follows:

$${C}_{t}^{Loss , Cal} = {[ {( \frac{{C}_{t - 1}^{Loss , Cal}}{{α}_{t}} )}^{\frac{1}{0.75}} + \frac{1}{86400} ]}^{0.75} , where \qquad ( 37 )$$

$${α}_{t} = ( {C}_{1} \cdot {V}_{t}^{Bat} - {C}_{2} ) \cdot {e}^{- \frac{{C}_{3}}{{T}_{t}^{Bat}}}$$

$$\begin{matrix}{C}_{t}^{Loss , Cycle} = {{β}_{t} [ {( \frac{{C}_{t - 1}^{L oss , Cycle}}{{β}_{t}} )}^{2} + Δ {Q}_{t} ]}^{0.5} , & where\end{matrix} \qquad ( 38 )$$

$${β}_{t} = {C}_{4} \cdot {( {ϕV}_{t} - {C}_{5} )}^{2} + {C}_{6} + {C}_{7} Δ D O {D}_{t}$$

where Cₜ^{loss,Cal} is the calendar loss in t, Tₜ^{Bat} is the battery temperature in t, Vₜ^{Bat} is the voltage of the battery in t, Cₜ^{loss,Cycle} is the cycle loss in t, ΔDODₜ is the average depth of discharge in t, ΔQₜ is the battery throughput within t, ϕVt is the quadratic average voltage of the battery at time t, and C₁ to C₇ are constants.

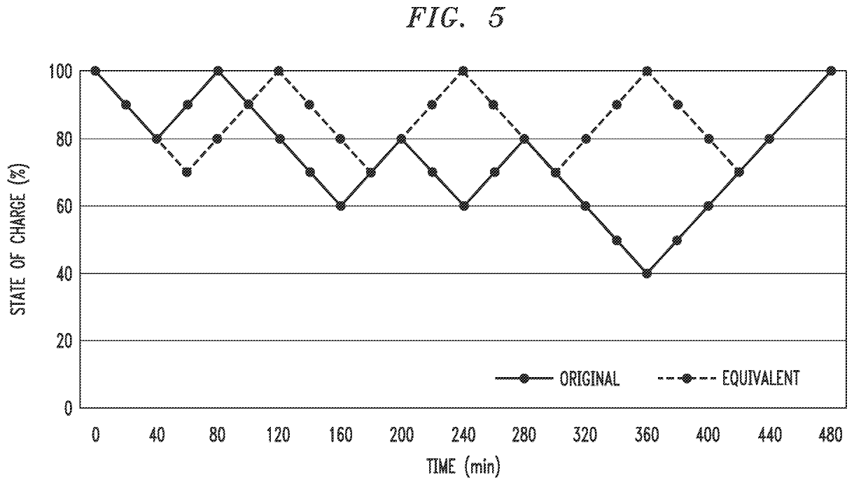

Discharge depth is an important factor in battery aging. For most battery chemistries, deep cycles cause strong aging compared to shallow cycles. In an electric vehicle, it is hard to calculate the DOD because the SOC is rarely 100% and discharging can start at any SOC value. Consequently, some assumptions are made so that the average DOD can be estimated. The first assumption is that the impact of SOC change is independent of the initial SOC. Therefore, the impact of SOC dropping from 80% to 60% is the same as that from 50% to 30%. The second assumption is that the SOC change on fading is independent of time. According to these two assumptions, the two cycles illustrated in the example SOC profiles of FIG. 5, namely, an original cycle and an equivalent cycle, have the same average DOD.

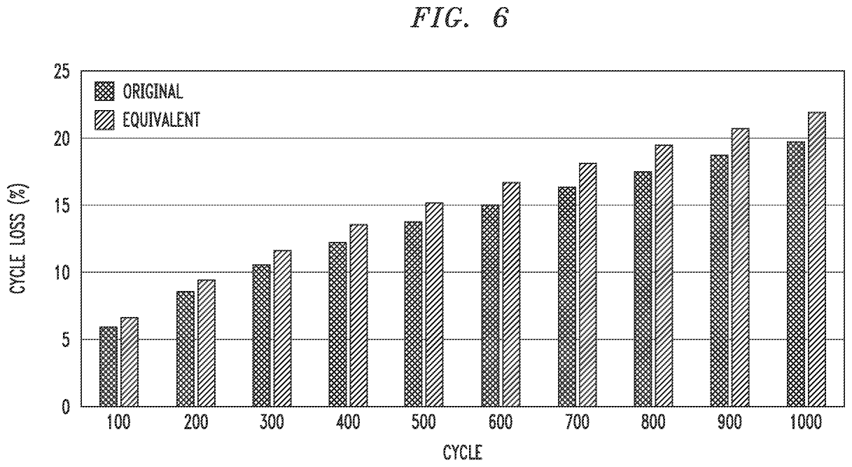

To validate the aforementioned assumptions, a simulation of these two cycles was carried out. Only the cycle fading behavior is considered since the DOD only affects the cycle fading behavior. Calendar aging and temperature are fixed. Moreover, to limit the impact of the current ratio, the battery is charged and discharged at constant current and maintains a low current ratio. The results are demonstrated in FIG. 6, which shows cycle fading of the original cycle and the equivalent cycle with different circulations. According to these results, the differences of cycle fading between two cycles are limited, and the differences can be explained by the fact that the original cycle has a lower quadratic voltage which leads to a slow cycle fading. Therefore, in some embodiments herein, the average DOD is calculated based on these two assumptions.

Interaction within Example Framework

With the example scheduling optimization problem described above, the optimal scheduling for fixed timespan T can be acquired. Yet, to further improve the solution quality, the scheduling optimization problem is integrated with the electric vehicle simulation model using a rolling horizon. Therefore, the following description explains the interaction within the framework, the implementation of the rolling horizon and the interaction between the scheduling optimization problem and the electric vehicle simulation model.

Rolling Horizon Implementation

FIG. 7 shows an example rolling horizon implementation with a look-ahead period used in some embodiments disclosed herein. This figure shows multiple sequences of time slots that are illustratively part of respective multiple instances of an iterative planning horizon. The multiple instances of the iterative planning horizon collectively defining an operating time horizon corresponding to a lifespan of a battery of a corresponding electric vehicle. Each such instance of the iterative planning horizon as illustrated comprises a roll period portion and a look-ahead period portion.

As mentioned previously, instead of maximizing the profit of the AET within the lifespan of the battery, the example scheduling optimization problem focuses on maximizing the profit within a fixed timespan T However, solving an optimization problem over a timespan T can only guarantee maximization of the profit generated within the timespan and cannot capture the future ride request information. This results in a low SOC at the end of timespan T and affects the performance on the next timespan. Therefore, to avoid such a situation, a look-ahead period is added to capture the future ride information as illustrated in FIG. 7. By solving the economic maximization problem for the planning horizon, the optimal scheduling can be acquired. However, only the binary variables for the roll period, u_{i,t}, t∈T, are utilized in the electric vehicle simulation model.

Interactions within the Simulation-Based Optimization Framework

The electric vehicle simulation model and the optimization framework described previously are coupled to form a simulation-based optimization framework as disclosed herein. By solving the optimization problem for the time horizon T, the optimal schedule can be acquired and fed into the AET simulation model, which generates the precise battery status information, including the capacity loss, SOC, and correction factors, such as the temperature impact factor. These parameters are used as the initial values for the next subproblem. Based at least in part on received ride request sequences, the economic maximization problem for time period T+1 is generated and solved. Then the process repeats until reaching the end of the operating time horizon.

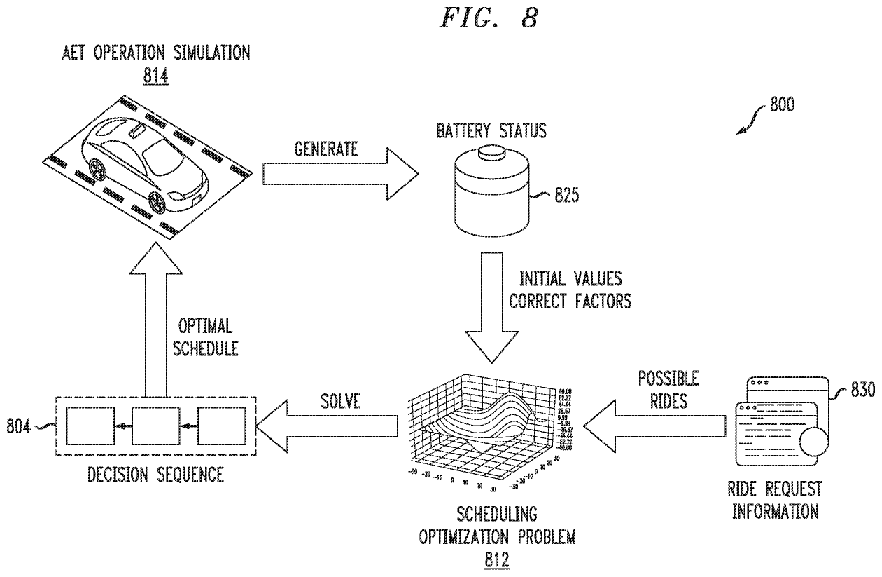

FIG. 8 shows an example simulation-based optimization framework 800 that illustrates the interaction between a scheduling optimization problem of a scheduling optimizer 812 and an electric vehicle simulator 814. The scheduling optimizer 812 and electric vehicle simulator 814 illustratively correspond to example implementations of the respective scheduling optimizer 112 and electric vehicle simulator 114 of the simulation-based optimization framework 110 in the processing platform 105 of FIG. 1. In this embodiment, a decision sequence 804 corresponding to a solution to a subproblem is provided by the scheduling optimizer 812 to the electric vehicle simulator 814, and used to generate updated values of battery status information 825 which are provided back to the scheduling optimizer 812 for use as initial values and correct factors for the next subproblem. Ride request information 830 is also provided as input to the scheduling optimizer 812 as shown.

One important parameter to be updated is the SOC changes of four operations in a fixed timespan T, OP_{T}. In each problem, the value of OP_{T} is assumed to be constant. However, in the long term, the value of OP_{T} varies due to the battery fading and environmental temperature changes. Therefore, by taking advantage of the detailed simulation, F_{Fade} and F_{T} are introduced to calibrate the SOC changes, OP_{T}, as follows:

OP_{T}=OP₀·F_{Fade,T}·F_{T} (39)

O_{P0} is the base case of SOC change which does not consider the impacts of temperature and capacity fading on SOC change. The temperature correction factor, F_{T}, is calculated using linear interpolation between the tabulated values given in the above-cited Y. Cao et al. reference. F_{Fade,T}, the correction factor for the battery fade, can be directly calculated by the fading history as follows:

F_{Fade,t}=1−Cₜ^{loss,Cycle}−Cₜ^{loss,Cal} (40)

In the optimization problem, the initial SOC, quadratic mean of voltage and the temperature of the battery are updated based on the simulation result. The optimal schedule, acquired from the scheduling optimization problem, instructed the simulation model to perform an AET operation simulation.

Case Study of Example Framework

The operation of an illustrative embodiment of a simulation-based optimization framework as disclosed herein will now be demonstrated in the context of an AET operated in NYC. The performance of this framework is compared with a 24-hour (“24 hr”) rule-based strategy and an 8-hour (“8 hr”) rule-based strategy.

In this embodiment, it is assumed that the AET battery comprises a battery pack having 16 modules, with the cells in each module being connected as 74 cells in a parallel group, and six such groups in series. Such an arrangement is one example of a “battery” as that term is broadly used herein.

According to the trip data published by NYC Taxi & Limousine Commission, the number of trips is highly correlated with time. In the busy times, the number of ride requests surges. Therefore, to represent the majority of the taxis, which have ride requests in the busy times and are idle in others, we use the daily average ride request as the threshold to distinguish the busy time and idle time. The ride request sequence is generated based on the 2013 yellow taxi trip data. To represent NYC driving conditions, for the driving state, the AET is assumed to follow the NYC driving cycle, which features the city's traffic conditions.

It is further assumed that the AET has the same specification as the Tesla Model 3 which has the largest market share within the plug-in electric vehicle market. The unit price of the Li-ion battery is about $200/kWh, so the 75 kWh battery pack is assumed to have a value of $15,000. Besides the battery cost, other parts of the electric vehicle are depreciated using a five-year, 200% declining balance. The total fixed operating cost of the AET is assumed to be $3,575 per month. Pe, the penalty for a missed ride, is set as $20, representing the typical fare for two average rides in NYC.

The optimization problem and electric vehicle simulation model are coded in Python 3.7 on a processing device comprising an Intel Core i7-6700 CPU @ 3.40 GHz and 32 GB RAM, running a Windows 10 Enterprise, 64-bit operating system. Furthermore, the optimization problem is solved using the DIscrete and Continuous OPTimizer (DICOPT), which is a solver for mixed integer nonlinear programming (MINLP) problems that involve linear binary or integer variables and linear and nonlinear continuous variables. The relative gap is set to 0.002. Each MINLP subproblem in this illustrative embodiment contains 576 binary variables, and 1875 constraints.

Rule-Based Strategies

Two rule-based control strategies, namely, a 24 hr rule-based strategy and an 8 hr rule-based strategy, are used to compare the battery lifespan and the economic performance of the AET operated with the example simulation-based optimization framework. With the driverless technology, the AET can operate all day. The 8 hr rule-based strategy resembles a taxi with the driver working 8 hours a day. The labor cost of the driver in these two rule-based strategies is not considered for a fair comparison.

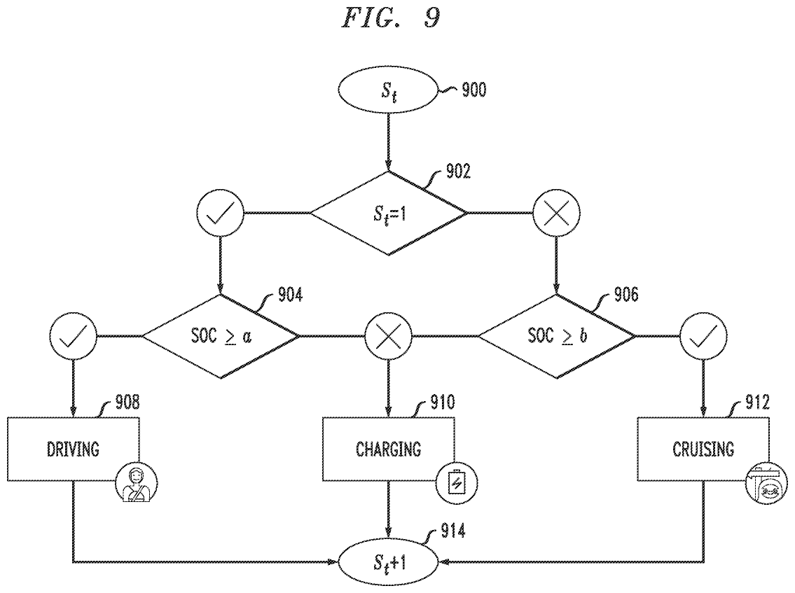

FIG. 9 illustrates an example set of rule-based control strategies within working hours. In this example, the actions of the AET are determined by the ride status, Sₜ, and the SOC at the beginning of time slot t, SOCₜ. The process is initialized for a given time slot at step 900. If there is a ride request at time slot t, as indicated by Sₜ=1 in step 902, and the SOC is greater than or equal to threshold a, as determined in step 904, the AET performs driving in time slot t to fulfill a ride request in step 908. If there is a ride request and its SOC is less than a, as determined in step 904, the AET goes to charge in step 910. The threshold b in step 906 is used to determine the action of the AET in an idle time slot. If its SOC is higher than b, then the AET performs cruising in step 912; otherwise, the AET goes to charge in step 910. At the end of the current time slot, the ride status for the next time slot is initialized in step 914, and the process repeats. The values of a and b are determined to be 10% and 50% by grid searching. For the 8 hr rule-based strategy, after the 8 working hours, the vehicle is parked.

Capacity Fade

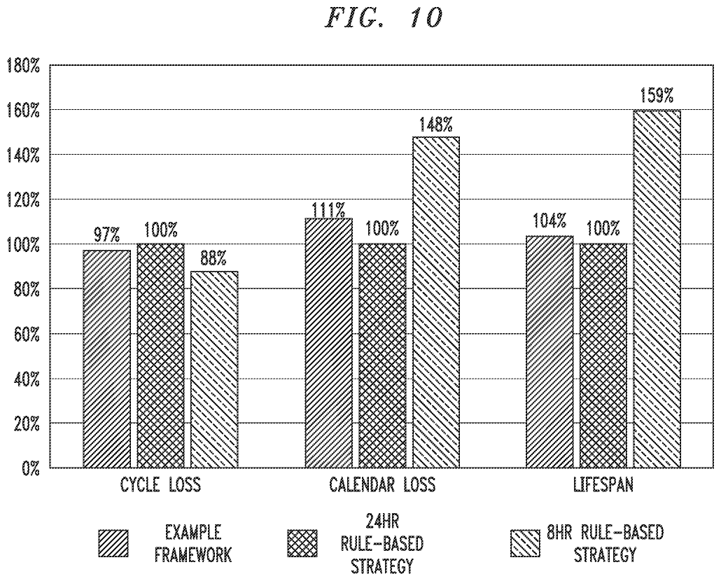

FIG. 10 compares the performance of the example simulation-based optimization framework, the 24 hr rule-based strategy, and the 8 hr rule-based strategy for calendar loss, cycle loss and battery life span of the battery.

Since the battery is the most expensive component in the electric vehicle, the battery's fading behavior has a great impact on the economic performance of the AET. Following the standard criteria for replacement of the battery, in this embodiment, the battery needs to be replaced once it loses 20% of its nominal capacity. Therefore, FIG. 10 shows the fading behavior under the example simulation-based optimization framework, the 24 hr rule-based strategy and 8 hr rule-based strategy. According to the result, for the example framework, a total of 1511 subproblems are formulated and solved consecutively, and 1511 days of simulation are performed before reaching the battery replacement criterion. Whereas, 1459 days and 2326 days of simulation are performed for the 24 hr rule-based strategy and the 8 hr rule-based strategy, respectively. From the lifespan perspective, the disclosed simulation-based optimization framework can help to extend the battery life by about 3%, compared to that of the 24 hr rule-based strategy. The 8 hr rule-based strategy has the longest lifespan because it has the shortest working hours among these scenarios. A shorter working time means less battery throughput in each day and results in a slow increase in cycle loss, which is the major contributor to the overall capacity loss for AETs. Therefore, the 8 hr rule-based scenario has the longest battery lifespan and the highest calendar loss. Besides the battery throughput, the quadratic voltage and average DOD also affect the cycle loss. With proper control on these parameters, the example simulation-based optimization framework's cycle loss is 3% lower than that of the 24 hr rule-based strategy, given a 3% longer lifespan. As for the calendar loss, although the example framework helps to extend the lifespan by 3%, its calendar loss is 11% higher than that of the 24 hr rule-based strategy. The reason is that it has an average of 48% SOC, which is 6.8% higher than the rule-based strategy leading to a higher battery voltage. According to Eq. (37), a high average battery voltage leads to faster calendar fading.

Economic Analysis

TABLE I
Daily Economic Performance for Example
Simulation-Based Optimization Framework,
24 hr Rule-based Strategy, and 8 hr Rule-based Strategy

| Strategy | Framework | 24 hr Rule-based | 8 hr Rule-based |
|---|---|---|---|
| Electricity Cost ($/day) | 13.3 | 13.2 | 5.01 |
| Battery Cost ($/day) | 9.93 | 10.3 | 6.45 |
| Parking Cost ($/day) | 7.00E−2 | 0 | 0 |
| Depreciation Cost ($/day) | 19.3 | 20.0 | 12.6 |
| Fixed Operating Cost | 119 | 119 | 119 |
| ($/day) | | | |
| Profit ($/day) | 268 | 262 | 51.4 |
| Average Missed Ride | 5.29E−3 | 6.40E−2 | 0 |
| (missed ride/day) | | | |

The parking rate is assumed to be $27/hr which is the average private parking rate in NYC. The electricity price is $0.176/kWh. The variable cost includes electricity cost, battery cost, parking cost, and depreciation cost. To avoid the daily fluctuation in the number of ride requests, the average daily economic performance is listed in Table I.

The electricity cost difference between the example framework and the 24 hr rule-based strategy is small. Whereas in the 8 hr rule-based scenario, the electricity cost is reduced by about 40% because of its short working hours. The decrease in electricity cost is not linear to the working hours, because the AET has a high frequency of ride requests during the working hours of the 8 hr rule-based scenario. At most times, the example framework prefers cruising rather than parking, because the benefits, including the lower electricity consumption and slower battery fading, brought by parking do not surpass the parking cost. Therefore, the electricity consumed is almost the same as the 24 hr rule-based strategy. The daily battery and depreciation cost are directly related with the lifespan of the battery. Therefore, the 8 hr rule-based strategy, which has the lowest daily battery usage, has the lowest variable cost, including the electricity cost, battery cost, parking cost, and depreciation cost. Yet, due to the short working time and less daily rides, the 8 hr rule-based strategy has the lowest daily electricity cost. Because of fewer daily missed rides and long working time, the example framework can increase the daily profit by 2% and 520% compared with 24 hr rule-based strategy and 8 hr rule-based strategy, respectively, although it has a slightly higher daily cost than that of the 24 hr rule-based strategy and much higher than that of 8 hr rule-based strategy.

Runtime Analysis

TABLE II
Runtime for Example Simulation-Based Optimization Framework,
24 hr Rule-based Strategy and 8 hr Rule-based strategy

| Strategy | Framework | 24 hr Rule-based | 8 hr Rule-based |
|---|---|---|---|
| Average (CPUs) | 14.4 | 6.07 | 6.02 |
| Total (CPUs) | 2.17E4 | 8.86E3 | 1.40E4 |

The average runtime and the total runtime for the three aforementioned strategies are listed in Table II. The example framework has the largest average runtime, while the runtimes of 24 hr rule-based strategy and 8 hr rule-based strategy. The reason is that the example framework takes extra time to solve the economic maximization problem, which increases the average runtime by about eight seconds. As for the total runtime, the 24 hr rule-based strategy and the 8 hr rule-based strategy have much lower total runtime than the example framework because there is no need to solve the optimization problem.

Sensitivity Analysis

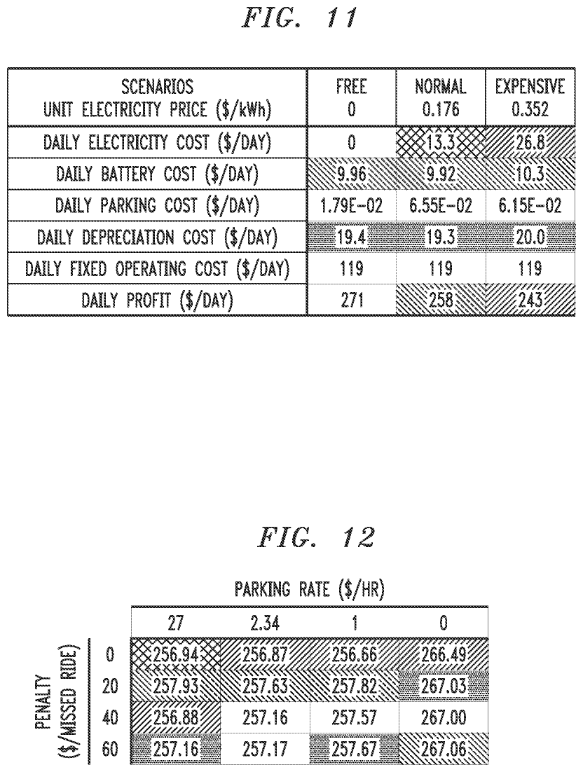

According to Table I, the electricity cost is the second largest contributor to the total cost. Therefore, a sensitivity analysis of electricity price is conducted, and the results are summarized in FIG. 11. In this embodiment, we only consider three scenarios, namely free electricity, normal electricity cost and expensive electricity. These three scenarios capture all the unit electricity price within the United States.

FIG. 11 shows the daily economic performance with different electricity prices of the example simulation-based optimization framework.

The daily profit decreases as the unit electricity price increases. Compared with the daily profit with free electricity, the daily profit decreases by about 5% and 10% in normal and expensive electricity scenarios, while the total cost increases by about 9% and 19% from free electricity to normal and expensive electricity. The unit price of the electricity also affects the charging behavior and causes a different lifespan. With an expensive electricity price, the example framework tries to charge the battery at low SOC to reduce the charging cost, because the internal resistance of the battery is high in high SOC. Therefore, the average SOC of the expensive electricity scenario is 6% lower than that of the free electricity scenario, resulting in a fast cycle fade and high daily depreciation cost.

This illustrative embodiment initially assumes that only private parking is available. However, besides parking in a private garage, sometimes street parking and free parking are available. To investigate the impact of parking rates on the economic performance of the AET with the example simulation-based optimization framework, four scenarios, namely, private parking, street parking, corner parking, and free parking are studied.

FIG. 12 shows daily profit with different penalty and parking rate values.

In NYC, the average private parking cost about $27/hr. Whereas the average street parking in NYC is $2.34/hr and the cheapest street parking is $1/hr. The free parking is of course $0/hr. The corner parking scenario is added to consider the case of a low parking rate. Moreover, a sensitivity analysis for the missed ride penalty, Pe in Eq. (9), ranging from no penalty to $80/missed ride, is conducted. Without a missed ride penalty, in different parking rate scenarios, the economic performance of the simulation-based optimization framework is poor. The reason is that, in the beginning, when the battery is brand new and with no capacity loss, the capacity decreases fast. The framework prefers parking over other operations leading to a high missed rate and low daily profit. Therefore, as the missed ride penalty increases to $20/missed ride, the daily profit increases in all scenarios. However, as the penalty further increases, the daily profit starts to decline and remains at certain levels. Indeed, with an increasing missed ride penalty, the missed ride rate decreases. For the first three scenarios, most of the missed rides happen within a continuous ride request sequence. The AET cannot fulfill all the ride requests if the initial SOC of the AET is not high enough. However, as the missed ride penalty increases, the example framework can avoid this situation by increasing the initial SOC through adjusting the operation before the continuous ride request sequence, such as parking instead of cruising. However, adjusting the operations will decrease the battery performance and incur parking cost, leading to a reduction in daily profit. As for the free parking scenarios, most of the missed rides happen in the beginning due to free parking and high capacity loss. Therefore, as the penalty increases, the AET is forced to pick up more rides, leading to an increase in daily profit. Overall, because the number of missed rides is only a small fraction of the total number of ride requests, the impact of a missed ride penalty on daily profit is relatively low. As for the impact of the parking rate, there is not a significant difference between the first three scenarios. This is because the battery and electricity cost of cruising on the street reduces quickly in the beginning and becomes lower than the parking rate within a short period. Therefore, there is not much difference if the AET needs to pay a parking rate. Only free parking can increase daily profit by about 3.6%.

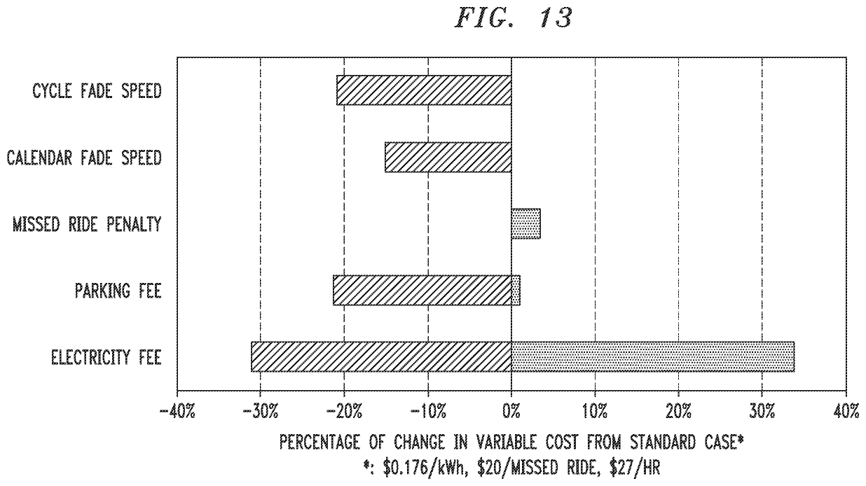

In the previous sensitivity analysis, we compare the daily profit in different scenarios. However, the variation is small due to the high fixed operating expenses. To better study these factors' impacts on the AET's economic performance, we perform a sensitivity analysis based on the variable cost, which excludes the fixed operating cost. Further, in recent years, different techniques have been proposed to slow down the capacity fading process. To reflect the impact of such techniques, we perform a sensitivity analysis on the fading speed with up to 30% reduced fading speed. The result is illustrated in FIG. 13, which shows sensitivity analysis of variable costs in different scenarios.

Within all these factors, the electricity unit price has the largest impact on the variable cost, showing a 31% reduction in free electricity scenario and a 34% increase with $0.352/kWh electricity price. As for the parking cost, the AET is benefited economically from the free parking leading to a 21% decrease in variable cost. Either an increase or a decrease of the missed ride penalty leads to a decrease in daily profit. As mentioned previously, an increase in missed ride penalty pushes the AET to park more often, leading to high parking costs. As for the capacity loss, reducing fading speed in both fading behaviors causes a decrease in variable cost. However, in the same reducing scale, the AET benefits more from the reduced cycle fade than from the reduced calendar fade. The reason is that, for the AET, the cycle loss is the major contributor to the total capacity loss.

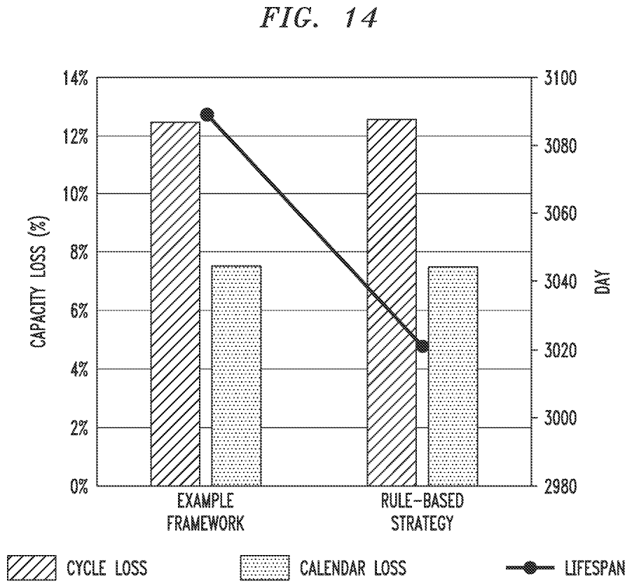

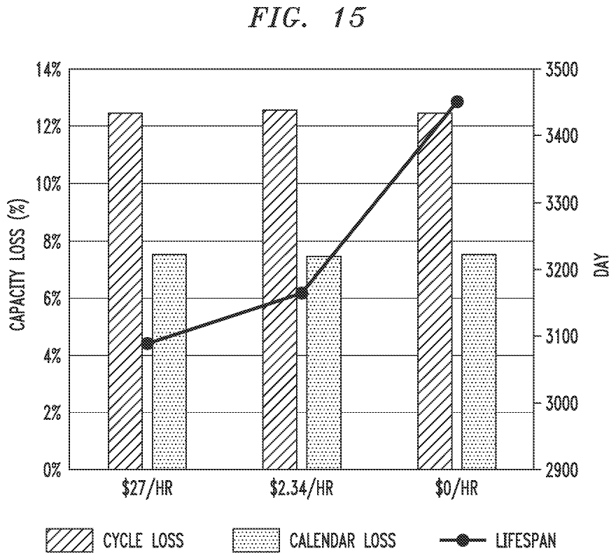

Additional performance data of illustrative embodiments are shown in FIGS. 14 and 15. More particularly, FIG. 14 shows plots comparing performance of an example simulation-based optimization framework to a rule-based strategy for cycle loss, calendar loss and battery lifespan in an illustrative embodiment, and FIG. 15 shows plots illustrating performance of an example simulation-based optimization framework under different parking fee conditions in an illustrative embodiment.

As illustrated in FIG. 14, the fading behavior of an example simulation-based optimization framework is compared to a rule-based strategy. With the example framework, the AET demonstrates a more flexible control on the battery voltage leading to a slow calendar fading. Compared with the rule-based strategy, the example framework has an average 45.9% SOC, which is 14% lower than the rule-based strategy leading to a lower average battery voltage. As indicated elsewhere herein, a lower battery voltage lowers the fading speed. As for the cycle fade, the difference between the example framework and the rule-based strategy is less pronounced. The reason is that the AET is assumed to work in a city where private parking is relatively expensive, for example the average parking price is $27/hour in NYC. The example framework favors cruising streets instead of paying for the expensive parking fee. Therefore, the example framework and the rule-based strategy both tend to choose to cruise streets, leading to a small difference in the cycle loss.

With reference now to FIG. 15, from the perspective of the fading composition, the ratio between the cycle loss and the calendar loss is almost the same. However, the service time of the battery increases as the parking fee decreases. This can be explained by the increasing time of parking during the idle time, slowing down the cycle fading. Moreover, for street and free parking, the parking options provide a positive economic benefit. In particular, compared with the private parking scenario, the free parking can extend the battery's lifespan by 10%.

The particular aspects of the example framework as described above in conjunction with FIGS. 9 through 15 are illustrative only, and should not be considered as limiting in any way. Numerous other embodiments with additional or alternative features will be apparent to those skilled in the art.

Some embodiments disclosed herein provide a simulation-based optimization framework for an AET to achieve economic maximization by optimal scheduling. For example, in illustrative embodiments, the operating time horizon for the AET is divided into a sequence of consecutive time slots, in which the AET can perform one of the four operations, including driving, cruising, charging, and parking. Instead of solving the integrated scheduling problem for the whole operating horizon, a moving horizon approach was applied to decompose the integrated problems into a set of subproblems. A look-ahead window was added to ensure the subproblems could consider future ride request information. After solving the optimal scheduling problem, the AET's operation was simulated by an electric vehicle simulation model to generate precise battery information and update the parameters which are used as the initial values of corresponding parameters for the optimization problem in the next timespan.

To validate the performance of an example simulation-based optimization framework, a case study of an AET operated in NYC was conducted and compared with the 24 hr rule-based strategy and the 8 hr rule-based strategy. Because of the shortest working time, the 8 hr rule-based strategy generated the lowest daily profit, while having the longest battery lifespan. Compared with the 24 hr rule-based strategy, the example simulation-based optimization framework can extend the battery lifespan by 3%, while increasing the daily profit by 2% and significantly reducing the daily missed ride. Sensitivity analysis was performed to investigate the impact of the parking rate, unit electricity price, and missed ride penalty to AET's economic performance. Free parking can increase the daily profit by about 3.6% and reduce the variable cost by about 21%. The electricity cost accounted for a large portion of the total cost. The results show that the daily profit increased by 5%, and variable cost decreased by 31% with free electricity. As the unit electricity price doubled, the daily profit decreased by 6% and the variable cost was 34% higher. The number of missed rides decreased as the missed ride penalty increased. Reduction in both capacity fade behaviors helped to lower the variable cost, while promoting the daily profit. The cycle fade was the dominant capacity fading behavior, and the AET benefited more from the reduction in cycle fade speed than from reduction in calendar fade. Other embodiments can incorporate the parking availability of different parking methods, using more precise geographic information into the optimization model, and considering several types of potential uncertainty involved in the AET operation, such as the fluctuation of the electricity price, to provide additional performance improvements.

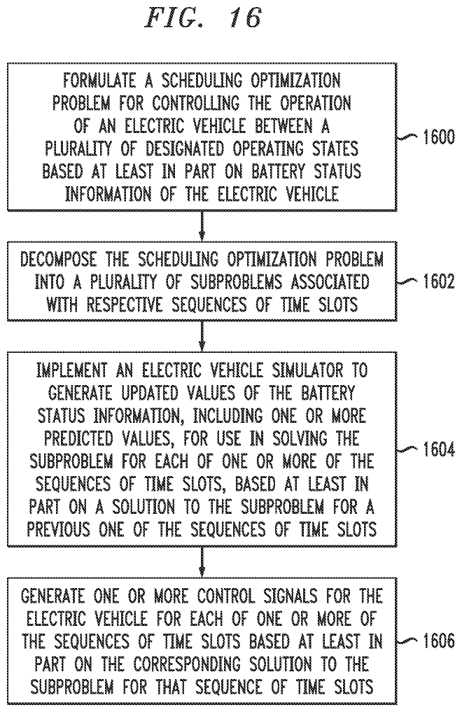

FIG. 16 shows another illustrative embodiment of a process for controlling electric vehicles using a simulation-based optimization framework in an illustrative embodiment. The process as shown includes steps 1600 through 1606, and is assumed to be collectively performed by one or more processing devices, such as one or more processing devices of the processing platform 105 in system 100 of FIG. 1. Other arrangements of one or more processing devices can be configured to implement the process in other embodiments.

In step 1600, a scheduling optimization problem is formulated for controlling the operation of an electric vehicle between a plurality of designated operating states based at least in part on battery status information of the electric vehicle.

In step 1602, the scheduling optimization problem is decomposed into a plurality of subproblems associated with respective sequences of time slots.

In step 1604, an electric vehicle simulator is implemented to generate updated values of the battery status information, including one or more predicted values, for use in solving the subproblem for each of one or more of the sequences of time slots, based at least in part on a solution to the subproblem for a previous one of the sequences of time slots.

In step 1606, one or more control signals are generated for the electric vehicle for each of one or more of the sequences of time slots based at least in part on the corresponding solution to the subproblem for that sequence of time slots.

The particular processing operations and other functionality described in conjunction with the flow diagram of FIG. 16 are presented by way of illustrative example only, and should not be construed as limiting the scope of the invention in any way. Alternative embodiments can use additional or alternative processing operations involving simulation-based optimization for controlling one or more electric vehicles. For example, the ordering of the process steps may be varied in other embodiments, or certain steps may be performed concurrently with one another rather than serially. Also, multiple instances of the process may be performed for respective different electric vehicles.

Functionality such as that described in conjunction with the flow diagram of FIG. 16 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a processor-readable storage medium.

Other illustrative embodiments include, for example, other types of information processing systems that implement simulation-based optimization frameworks as disclosed herein for controlling the operation of one or more electric vehicles.

Some embodiments provide systems and methods for a simulation-based optimization framework for operation and control of electric vehicles, especially autonomous electric vehicles. The systems and methods are applied to autonomous vehicles, such as electric or hybrid electric autonomous vehicles. In some embodiments, a simulation-based optimization framework is implemented to control an electric vehicle, such as an electric taxi, an electric vehicle for sharing, an electric truck, etc. In other embodiments, a simulation-based optimization framework is implemented to control electric aircraft and electric vessels/ships, such as autonomous electric aircraft and autonomous electric vessels/ships. The term “electric vehicle” as used herein is therefore intended to be broadly construed.

In some embodiments, an electric vehicle comprises a battery system configured to provide power for an electric motor of the vehicle; a sensor system comprising a plurality of sensors configured to detect and/or receive data, wherein the data comprising at least one environmental parameter of the electric vehicle and/or at least one parameter of at least one component of the electric vehicle, wherein the at least one component of the electric vehicle comprising the battery system; a control system configured to control the operation of the electric vehicle; a user interface configured to receive input data from a user and display output data to the user; a data storage system configured to store data; and at least one processor wherein the processor comprises a simulation system, an optimization system, a rule-based decision system and/or the combination thereof.

The electric vehicle may be an autonomous electric vehicle such as an AET, or another type of electric vehicle. Examples of other types of electric vehicles that can be controlled using the techniques disclosed herein include an electric vehicle for sharing, an electric truck, an electric vessel and/or electric aircraft. Electric vehicles as that term is broadly used herein can therefore comprise, for example, an autonomous road vehicle, an autonomous vessel and/or an autonomous airborne vehicle such as a drone.

In some embodiments, at least one processing device comprises a simulation system and an optimization system.

The simulation system illustratively comprises a power simulation subsystem configured to calculate the demanded power for a set of operation scenarios comprising speed acceleration, deceleration, and/or the maintain of the current speed and a battery simulation subsystem configured to calculate the current status of the battery, at least one profile of the battery, state of charge, state of battery health, capacity loss, and/or the combination thereof, wherein the profile comprises a current and/or a voltage profile.

The optimization system is illustratively configured to receive input data from the sensor system and/or the simulation system and is further configured to optimize at least one objective, the at least one objective being selected from one or more of maximizing total profit, minimizing total cost, maximizing the lifetime of electric vehicle, maximizing the lifetime of one or two components of the electric vehicle, minimizing travel time/route, and/or minimizing energy consumption, and wherein the optimization system is further configured to output results relating to optimal decisions to reach the objective.

A control system illustratively receives the output results from the optimization system and controls the operation of the electric vehicle.

In some embodiments, the sensor system comprises one or more sensors associated with the state, status and/or environment of the electric vehicle or one or more parts of the electric vehicle (e.g., battery sensor, steering wheel sensor, imaging sensor, spatial sensor, location sensor, temperature sensor, humidity sensor, weather condition sensor, radiation sensor, weight sensor, and/or other sensors) and configured to provide associated data as input for further processing. The sensor system may comprises one or more exterior sensors located on an exterior surface of the vehicle (e.g. image sensors, environmental sensors) and one or more interior sensors located on or in the interior part of the vehicle (e.g. battery sensors, weight sensors). Numerous other arrangements of sensors can be used in a given sensor system of an electric vehicle in other embodiments.

In some embodiments, the optimization system is further configured to set or select a set of constraints, wherein the constraints are selected from a list of task constraints, a list of operation constraints, a list of car condition constraints, and/or a list of environmental constraints and the combination thereof. The task constraints illustratively comprise travel plan, and/or loading plan. The operation constraints illustratively comprise driving, charging, parking/resting, and/or optionally cruising operations or any combination thereof. The car condition constraints illustratively comprise battery conditions, electric motor conditions, or any combination thereof. The environmental constraints illustratively comprise temperature, weather conditions, radiation, parking availability, parking fee, electricity price, speed limit, traffic condition, road condition, and/or any combination thereof.

A simulation system in some embodiments comprises a cooling/thermal simulation subsystem configured to simulate the temperature conditions and/or controls of thermal conditions of the battery and/or electric motor, and an aging/fading/depreciation simulation subsystem configured to simulate the depreciation, aging and/or fading of at least one component of the electric vehicle, such as a battery and/or an electric motor. Such a simulation system and/or individual ones of its subsystems can conduct simulation periodically, in real-time, or as required, in any combination.

In some embodiments, the aging/fading/depreciation simulation subsystem is configured to receive data from sensors, from simulation results of the thermal simulation subsystem, and/or historical data, or any combination thereof, to calculate the aging/fading/depreciating behavior of the at least one component of the electric vehicle via one or more models for each of the one or more components of the electric vehicle, and to send the calculated results to the optimization system. At least one of the one or more models illustratively comprises a non-linear model.

In some embodiments, the battery model used in the battery simulation subsystem is selected from mathematical models, electrochemical models, equivalent circuit models and/or the combination thereof.

In some embodiments, the battery simulation subsystem simulates the battery condition based on cycle fade and calendar fade data.

In some embodiments, the output results from the optimization system comprise operation plans and/or schedules for the control system to control the operations of the electric vehicle.

In some embodiments, the aging/fading/depreciation simulation subsystem runs about weekly, daily, every 1, 2, 3, 4, 5, 6 days, every 1, 2, 3, 4, 6, 8, 12 hours, every 1-60 minutes, or any intervals within the ranges.

An electric vehicle and/or an associated processing platform as disclosed herein illustratively comprises an optimization solver configured to receive an objective function and a set of constraints, and return the optimized control decisions for the control system.

The optimization solver illustratively comprises a mixed integer linear programming solver, a mixed integer non-linear programming solver, a non-linear programming solver, and/or the combination thereof.

In some embodiments, the interactions of simulation system and optimization system are iterative, wherein some parameters for the input of the optimization system are simulation results from the simulation system, and some parameters for the input of the simulation system are operation results calculated by the optimization system, and executed or will be executed by the control system.

An example processor illustratively comprises a rule-based decision system wherein the operation decisions of the electric vehicle are selected from a series of operation scenarios comprise driving, charging, cruising and parking/resting, wherein the selection of the operation scenario is determined by at least one predetermined threshold value of at least one property of the electric vehicle or the status of the electric vehicle. For example, the at least one property of the electric vehicle illustratively comprises status of charge, and the status of the electric vehicle illustratively comprises a ride request. The at least one predetermined threshold value of at least one property of the electric vehicle is illustratively calculated by a simulation system and/or an optimization system.

Some embodiments further comprise a communication system with a remote cloud server system wherein the communication system is configured to receive data comprising ride request information, and upload data comprising at least one status of the electric vehicle.

In some embodiments, an electric vehicle comprises a battery system configured to provide power for an electric motor of the electric vehicle, a sensor system comprising at least one sensor to detect at least one environmental parameter of the electric vehicle, at least one parameter of at least one component of the electric vehicle, or both at least one environmental parameter of the electric vehicle and at least one parameter of the battery system, a control system configured to control the operation of at least one system of the electric vehicle, a power simulator configured to calculate the demanded power for a set of operation scenarios comprising speed, acceleration, deceleration, and/or the maintain of the current speed, a battery simulator system configured to calculate the current status of the battery, at least one profile of the battery, state of charge, state of battery health, capacity loss, and/or the combination thereof, wherein the profile comprises a current and/or a voltage profile, and an optimizer configured to receive input data from at least one of the sensor system, the power simulator, the battery simulator, and/or a communication system, to optimize an objective comprising a total profit, a total cost, a lifetime of the electric vehicle, a lifetime of a component of the electric vehicle, a lifetime of a group of components of the electric vehicle, a travel time, a travel route, an energy consumption, an average cost per distance unit, an average profit per distance unit, an average cost per time unit, and/or an average profit per time unit, or any weighted or unweighted combination of two or more objectives, and to determine inputs to the control system to cause the control system to operate the at least one system of the electric vehicle to achieve or approximate the optimized objective.

The optimizer in some embodiments is further configured to select a set of constraints from a plurality of selectable constraints, the plurality of selectable constraints comprising task constraints, operation constraints, car condition constraints and/or environmental constraints.

In some embodiments, an electric vehicle system comprises an electric vehicle, the electric vehicle comprising a battery system configured to provide power for an electric motor of the electric vehicle, a sensor system comprising at least one sensor to detect at least one environmental parameter of the electric vehicle, at least one parameter of at least one component of the electric vehicle, or both at least one environmental parameter of the electric vehicle and at least one parameter of the battery system, a control system configured to control the operation of at least one system of the electric vehicle, and a first communication system comprising a first communication device.

The electric vehicle system further comprises a remote system comprising a second communication system including a second communication device. The first communication system of the electric vehicle is illustratively configured to establish a communication pathway with the second communication system via the first communication device.

The electric vehicle or the remote system illustratively includes a power simulator configured to calculate a required power for a set of operation scenarios comprising acceleration, deceleration, and/or the maintenance of a set speed.

The electric vehicle or the remote system illustratively includes a battery simulator system configured to calculate a current status of the battery, a profile of the battery, a state of charge, a state of battery health, a capacity loss, and/or a combination thereof, wherein the profile comprises a current profile and/or a voltage profile.

The electric vehicle or the remote system illustratively includes an optimizer configured to optimize an objective using sensor data from the sensor system and/or an output from the power simulator and/or an output from the battery simulator, and/or data from the first and/or the second communication system, the objective comprising a total profit, a total cost, a lifetime of the electric vehicle, a lifetime of a component of the electric vehicle, a lifetime of a group of components of the electric vehicle, a travel time, a travel route, an energy consumption, an average cost per distance unit, an average profit per distance unit, an average cost per time unit, and/or an average profit per time unit, or any weighted or unweighted combination of two or more objectives, and to determine inputs to the control system to cause the control system to operate the at least one system of the electric vehicle to achieve or approximate the optimized objective.

The electric vehicle and/or the remote system is configured to output to the control system, via the first communication system and/or the second communication system, the inputs to the control system.

In some embodiments, the optimization system comprises an optimizer, and the simulation system comprises a simulator.

The optimization system or optimizer may be onsite or located in a remote central management system, wherein the electric vehicle communicates with the remote central management system through a first communication system and/or a second communication system.

The simulation system or simulator may be onsite or located in a remote central management system, wherein the electric vehicle communicates with the remote central management system through a first communication system and/or a second communication system.

As is apparent from the foregoing description, illustrative embodiments disclosed herein provide significant advantages relative to conventional approaches. For example, some embodiments provide a simulation-based optimization framework for controlling electric vehicles, such as autonomous electric vehicles. Such embodiments can advantageously extend battery life while also maximizing productivity of a fleet of electric vehicles. Numerous other advantages of illustrative embodiments are described elsewhere herein.

The particular system configurations and other features as shown in the figures are non-limiting and should be considered illustrative examples only. Numerous other types of system configurations, algorithms and models can be used in other embodiments. Those skilled in the art will also recognize that alternative processing operations and associated system entity configurations can be used in other embodiments.

It is therefore possible that other embodiments may include additional or alternative system elements, relative to the entities of the illustrative embodiments. Accordingly, the particular system configurations and associated algorithm implementations can be varied in other embodiments.

A given processing device or other component of an information processing system as described herein is illustratively configured utilizing a corresponding processing device comprising a processor coupled to a memory. The processor executes software program code stored in the memory in order to control the performance of processing operations and other functionality. The processing device also comprises a network interface that supports communication over one or more networks.

The processor may comprise, for example, a microprocessor, an ASIC, an FPGA or other programmable logic circuit, a CPU, a TPU, a GPU, an ALU, a DSP, or other similar processing device component, as well as other types and arrangements of processing circuitry, in any combination. For example, at least a portion of the functionality of a simulation-based optimization framework provided by one or more processing devices as disclosed herein can be implemented using such circuitry.

The memory stores software program code for execution by the processor in implementing portions of the functionality of the processing device. A given such memory that stores such program code for execution by a corresponding processor is an example of what is more generally referred to herein as a processor-readable storage medium having program code embodied therein, and may comprise, for example, electronic memory such as SRAM, DRAM or other types of random access memory, ROM, flash memory, magnetic memory, optical memory, or other types of storage devices in any combination.

As mentioned previously, articles of manufacture comprising such processor-readable storage media are considered embodiments of the invention. The term “article of manufacture” as used herein should be understood to exclude transitory, propagating signals. Other types of computer program products comprising processor-readable storage media can be implemented in other embodiments.

In addition, embodiments of the invention may be implemented in the form of integrated circuits comprising processing circuitry configured to implement processing operations associated with implementation of a simulation-based optimization framework for controlling electric vehicles.

An information processing system as disclosed herein may be implemented using one or more processing platforms, or portions thereof.

For example, one illustrative embodiment of a processing platform that may be used to implement at least a portion of an information processing system comprises cloud infrastructure including virtual machines implemented using a hypervisor that runs on physical infrastructure. Such virtual machines may comprise respective processing devices that communicate with one another over one or more networks.

The cloud infrastructure in such an embodiment may further comprise one or more sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the information processing system.

Another illustrative embodiment of a processing platform that may be used to implement at least a portion of an information processing system as disclosed herein comprises a plurality of processing devices which communicate with one another over at least one network. Each processing device of the processing platform is assumed to comprise a processor coupled to a memory. A given such network can illustratively include, for example, a global computer network such as the Internet, a WAN, a LAN, a satellite network, a telephone or cable network, a cellular network such as a 3G, 4G or 5G network, a wireless network implemented using a wireless protocol such as Bluetooth, WiFi or WiMAX, or various portions or combinations of these and other types of communication networks.

Again, these particular processing platforms are presented by way of example only, and an information processing system may include additional or alternative processing platforms, as well as numerous distinct processing platforms in any combination, with each such platform comprising one or more computers, servers, storage devices or other processing devices.

A given processing platform implementing a simulation-based optimization framework as disclosed herein can alternatively comprise a single processing device, such as a computer, mobile telephone or handheld device. It is also possible in some embodiments that one or more such system elements can run on or be otherwise supported by cloud infrastructure or other types of virtualization infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in an information processing system. Such components can communicate with other elements of the information processing system over any type of network or other communication media.

As indicated previously, components of the system as disclosed herein can be implemented at least in part in the form of one or more software programs stored in memory and executed by a processor of a processing device. For example, certain functionality disclosed herein can be implemented at least in part in the form of software.

The particular configurations of information processing systems described herein are exemplary only, and a given such system in other embodiments may include other elements in addition to or in place of those specifically shown, including one or more elements of a type commonly found in a conventional implementation of such a system.

For example, in some embodiments, an information processing system may be configured to utilize the disclosed techniques to provide additional or alternative functionality in other contexts.

It should again be emphasized that the embodiments of the invention as described herein are intended to be illustrative only. Other embodiments of the invention can be implemented utilizing a wide variety of different types and arrangements of information processing systems, networks and processing devices than those utilized in the particular illustrative embodiments described herein, and in numerous alternative processing contexts. In addition, the particular assumptions made herein in the context of describing certain embodiments need not apply in other embodiments. These and numerous other alternative embodiments will be readily apparent to those skilled in the art.

What is claimed is:

1. An apparatus comprising:
one or more processing devices each comprising a processor coupled to a memory;
the one or more processing devices being collectively configured:
to formulate a scheduling optimization problem for controlling the operation of an electric vehicle between a plurality of operating states based at least in part on battery status information of the electric vehicle;
to decompose the scheduling optimization problem into a plurality of subproblems associated with respective sequences of time slots;
to implement an electric vehicle simulator to generate updated values of the battery status information, for use in solving the subproblem for each of one or more of the sequences of time slots, based at least in part on a solution to the subproblem for a previous one of the sequences of time slots, the updated values of the battery status information including one or more predicted values; and
to generate one or more control signals for the electric vehicle for each of one or more of the sequences of time slots based at least in part on the corresponding solution to the subproblem for that sequence of time slots.

2. The apparatus of claim 1 wherein the one or more processing devices are implemented at least in part in a cloud-based processing platform configured to communicate with the electric vehicle over one or more networks.

3. The apparatus of claim 1 wherein the one or more processing devices are implemented at least in part in the electric vehicle.

4. The apparatus of claim 1 wherein the plurality of operating states comprise at least a subset of a driving state, a cruising state, a charging state and a parking state.

5. The apparatus of claim 1 wherein the operation of the electric vehicle is controlled between different ones of the plurality of operating states for different ones of the time slots of a given one of the sequences of time slots in accordance with the solution to the corresponding subproblem with the electric vehicle being assigned only one of the operating states within a given one of the time slots.

6. The apparatus of claim 1 wherein the electric vehicle simulator is configured to generate updated values of the battery status information at designated time intervals each having a duration that is substantially less than that of a given one of the time slots and further wherein the electric vehicle simulator takes as at least a portion of its inputs, for use in generating the updated values of the battery status information, one or more of (i) sensor readings from the electric vehicle, (ii) environmental readings associated with the electric vehicle, (iii) driving history information of the electric vehicle and (iv) predicted demand for the electric vehicle.

7. The apparatus of claim 1 wherein the electric vehicle simulator is configured to generate updated values of the battery status information that are applied as inputs to a first one of the subproblems for a first one of the sequences of time slots.

8. The apparatus of claim 7 wherein the electric vehicle simulator is configured to receive a solution to the first subproblem for the first sequence of time slots and to generate, based at least in part on the received solution to the first subproblem, updated values of the battery status information that are applied as inputs to a second one of the subproblems for a second one of the sequences of time slots.

9. The apparatus of claim 7 wherein a solution to the first subproblem comprises a decision sequence specifying a sequence of operating states of the electric vehicle for the first sequence of time slots.

10. The apparatus of claim 7 wherein the electric vehicle simulator is configured to receive solutions to respective additional ones of the subproblems for respective additional ones of the sequences of time slots and to iteratively generate, based at least in part on the received solution to one of the additional subproblems, updated values of the battery status information that are applied as inputs to a next one of the additional subproblems for a next one of the sequences of time slots.

11. The apparatus of claim 1 wherein the sequences of time slots are part of respective multiple instances of an iterative planning horizon, the multiple instances of the iterative planning horizon collectively defining an operating time horizon corresponding to a lifespan of a battery of the electric vehicle.

12. The apparatus of claim 11 wherein at least one of the multiple instances comprises a roll period portion and a look-ahead period portion.

13. The apparatus of claim 1 wherein the battery status information comprises one or more of state of charge, voltage, capacity loss and temperature.

14. The apparatus of claim 1 wherein the one or more predicted values comprise at least one of remaining life, state of health, capacity loss, power, voltage and current.

15. The apparatus of claim 1 wherein the scheduling optimization problem is formulated to maximize one or more performance measures of the electric vehicle subject to one or more state of charge constraints of a battery of the electric vehicle.

16. A computer program product comprising a non-transitory processor-readable storage medium having stored therein program code of one or more software programs, wherein the program code when executed by at least one processing device causes said at least one processing device:
to formulate a scheduling optimization problem for controlling the operation of an electric vehicle between a plurality of operating states based at least in part on battery status information of the electric vehicle;
to decompose the scheduling optimization problem into a plurality of subproblems associated with respective sequences of time slots;
to implement an electric vehicle simulator to generate updated values of the battery status information, for use in solving the subproblem for each of one or more of the sequences of time slots, based at least in part on a solution to the subproblem for a previous one of the sequences of time slots, the updated values of the battery status information including one or more predicted values; and
to generate one or more control signals for the electric vehicle for each of one or more of the sequences of time slots based at least in part on the corresponding solution to the subproblem for that sequence of time slots.

17. The computer program product of claim 16 wherein the operation of the electric vehicle is controlled between different ones of the plurality of operating states for different ones of the time slots of a given one of the sequences of time slots in accordance with the solution to the corresponding subproblem with the electric vehicle being assigned only one of the operating states within a given one of the time slots.

18. The computer program product of claim 16 wherein the electric vehicle simulator is configured:
to generate updated values of the battery status information that are applied as inputs to a first one of the subproblems for a first one of the sequences of time slots;
to receive a solution to the first subproblem for the first sequence of time slots; and
to generate, based at least in part on the received solution to the first subproblem, updated values of the battery status information that are applied as inputs to a second one of the subproblems for a second one of the sequences of time slots.

19. A method comprising:
formulating a scheduling optimization problem for controlling the operation of an electric vehicle between a plurality of operating states based at least in part on battery status information of the electric vehicle;
decomposing the scheduling optimization problem into a plurality of subproblems associated with respective sequences of time slots;
implementing an electric vehicle simulator to generate updated values of the battery status information, for use in solving the subproblem for each of one or more of the sequences of time slots, based at least in part on a solution to the subproblem for a previous one of the sequences of time slots, the updated values of the battery status information including one or more predicted values; and
generating one or more control signals for the electric vehicle for each of one or more of the sequences of time slots based at least in part on the corresponding solution to the subproblem for that sequence of time slots;
wherein the method is performed by at least one processing device comprising a processor coupled to a memory.

20. The method of claim 19 wherein the operation of the electric vehicle is controlled between different ones of the plurality of operating states for different ones of the time slots of a given one of the sequences of time slots in accordance with the solution to the corresponding subproblem with the electric vehicle being assigned only one of the operating states within a given one of the time slots.

21. The method of claim 19 wherein the electric vehicle simulator is configured:
to generate updated values of the battery status information that are applied as inputs to a first one of the subproblems for a first one of the sequences of time slots;
to receive a solution to the first subproblem for the first sequence of time slots; and
to generate, based at least in part on the received solution to the first subproblem, updated values of the battery status information that are applied as inputs to a second one of the subproblems for a second one of the sequences of time slots.
